(19) United States
(12) Patent Application Publication
(10) Pub. No.: US 2011/0306693 A1
(43) Pub. Date: Dec. 15, 2011

(54) Production of Polyhydroxyalkanoate Foam

(76) Inventors: Clive P. Bosnyak, Dripping Springs, TX (US); Thomas J. Pitzi, Princeton, MA (US); Chris Schwier, Boston, MA (US)

(21) Appl. No.: 13/132,571

(22) PCT Filed: Jun. 19, 2009
(86) PCT No.: PCT/US09/03669

§ 371 Date: Aug. 31, 2011

Related U.S. Application Data
(60) Provisional application No. 61/166,950, filed on Apr. 6, 2009.
(60) Provisional application No. 61/203,542, filed on Dec. 23, 2008.
(60) Provisional application No. 61/200,619, filed on Dec. 2, 2008.

(51) Int. Cl. C08J 9/06; C08J 9/35

(52) U.S. Cl. 521/91; 521/134; 521/135

(57) ABSTRACT

Cell nucleation compositions and pellets, methods for making same, methods and compositions for making polymer foam, and polymer foams made by the methods are disclosed.

### RELATED APPLICATIONS

This application claims the benefit of U.S. Provisional Application Nos. 61/200,619, filed on Dec. 2, 2008, 61/203,542 filed Dec. 23, 2008; and 61/166,950 filed on Apr. 6, 2009. The entire teachings of the above application is incorporated herein by reference.

### GOVERNMENT SUPPORT

The invention was supported, in whole or in part, by a grant Contract #: W912HQ-06-C-0011 from the Strategic Environmental Research and Development Program (SERDP). The Government has certain rights in the invention.

### TECHNICAL FIELD

The invention relates to foams made from biodegradable polyesters or blends of biodegradable polyesters, and methods of making such foams, compositions and pellets for making foams, and the like.

### BACKGROUND

Biodegradable plastics are of increasing industrial interest as replacements or supplements for non-biodegradable plastics in a wide range of applications and in particular for packaging applications. One class of biodegradable polymers is the polyhydroxyalkanoates (PHAs). These polymers are synthesized by soil microbes for use as intracellular storage material. Articles made from the polymers are generally recognized by soil microbes as a food source. There has therefore been a great deal of interest in the commercial development of these polymers, particularly for disposable consumer items. To date, however, PHAs have seen limited commercial availability, with only the copolymer poly(3-hydroxybutyrate-co-3-hydroxyvalerate) (PHBV) being available in development quantities.

Although various PHAs are capable of being processed on conventional processing equipment, many problems have been found with the polymers. These include lack of processability in some situations, which can limit the commercial applications available for use of the polymer. Molecular weight can be difficult to maintain. In addition, the crystallization kinetics of the polymer are poorly understood, and long cycle times are often required during processing of these polymers, further limiting their commercial acceptance. This especially limits the use of the polymers in applications involving foam.

### SUMMARY

Disclosed herein are methods and compositions for preparing a PHA polymer foam and polymer foams made by the methods. In one aspect, a method of preparing a polyhydroxyalkonate polymer foam is described by combining a PHA polymer, an epoxy functional compound, and a foam cell nucleating agent under conditions that cause reaction of the polymer with the epoxy functional compound forming a molten foam composition. The molten foam composition is then combined with a blowing agent under conditions that cause foaming of the molten foam composition and cooled forming a PHA polymer foam. In certain embodiments, the polymer is branched.

Alternatively, a branching agent is combined with the PHA polymer, the epoxy functional compound and the foam cell nucleating agent under conditions that cause branching of the PHA polymer, reaction of the polymer with the epoxy functional compound and forming a molten foam composition. The molten foam composition is then combined with a blowing agent under conditions that cause foaming of the molten foam composition and cooled forming a PHA polymer foam. In certain embodiments, the polymer is branched.

Also disclosed is a method of preparing a PHA polymer foam, by combining a PHA polymer and a branching agent under conditions suitable for branching and forming a branched polymer, combining the branched polymer with an epoxy functional compound and a foam cell nucleating agent under conditions that cause reaction of the polymer with an epoxy functional compound forming a molten foam composition. Then, combining the molten foam composition with a blowing agent under conditions that cause foaming of the molten foam composition, cooling and forming a polymer foam.

“Epoxy functional compound” as used herein is a compound with two or more epoxide groups capable of increasing the melt strength of polyhydroxyalkanoate polymers by chain branching, for example, end chain branching. In particular embodiments, the epoxy functional compound is an epoxy-functional styrene-acrylic polymer, an epoxy-functional acrylic copolymer, an epoxy-functional polyolefin copolymer, an oligomer comprising a glycidyl group with an epoxy functional side chain, an epoxy-functionalized poly(ethylene-glycidyl methacrylate-co-methacrylate), or an epoxidized oil or combinations thereof.

In one aspect a foam comprises “a plurality of PHA chains” connected through the epoxy functional compound. “A plurality of PHA chains” refers numerous PHA chains that are connected together by epoxy functional compounds.

As used herein, the molten foam composition comprises a PHA polymer, an epoxy functional compound, and a foam cell nucleating agent. In some embodiments, the molten foam composition further comprises a branching agent. Optionally, the molten foam composition further includes nucleating agents, additives and the like. In particular embodiments, the molten foam composition further comprises a nucleating agent, for example, boron nitride or cyanuric acid. In yet other embodiment, the molten foam composition further comprises a second epoxy functional compound or an additive.

The blowing agent for use in the methods and compositions is 1,1,1,2-tetrafluoroethane, butane, carbon dioxide, nitrogen, pentane, iso pentane or isobutane.

The invention also pertains to PHA polymer foam compositions and PHA polymer foams made by the methods described herein. In certain embodiments, the resultant PHA polymer foam has an expansion ration of 10 fold.

In another embodiment, a PHA polymer foam is provided. The polymer foam can be made by any of the methods described herein. The polymer foam can contain about 0.01% to about 5.00% by weight of the epoxy functional agent. The polymer foam can contain about 0.01% to about 4.00% by weight of the foam cell nucleating agent.

Also disclosed is an embodiment providing a composition for producing a polymer foam, which includes: a PHA, a foam cell nucleating agent, and epoxy functional compound(s). Also disclosed is an embodiment providing a composition for producing a polymer foam, which includes: a PHA, a foam cell nucleating agent, a branching agent (e.g., peroxide), and epoxy functional compounds In certain embodiment, the composition further includes a nucleating agent.

In any of the methods, compositions, foams or pellets described herein, the epoxy functional compound can be an epoxy-functional, styrene-acrylic polymer (e.g., Joncryl ADR-4368 or MP-40), or a glycidyl methacrylate (e.g., LOTADER®), or an epoxidized oil (e.g., epoxidized soybean oil, e.g., Merginat® ESBO or Edenol® B 316).

In any of the methods, compositions, foams or pellets described herein, the cell nucleating compound can be talc (e.g., Flextalc 610D) or the cell nucleating compound can be clay (e.g., SCPX3016).

In any of the embodiments disclosed, the polymer can be a polyhydroxyalkanoate. In particular embodiments the polymer is a branched polyhydroxyalkanoate polymer. Any of the methods, compositions, foams or pellets can include a nucleating agent. For instance, the nucleating agent can be dispersed into the cell nucleation composition

The blowing agent used in any of the methods or foams described herein can be R134a (1,1,1,2-tetrafluoroethane), butane, carbon dioxide, nitrogen, or any other blowing agent used in the foam-making industry. The blowing agent can be added at ratios of addition of about 0.1% to about 10.0%. It can be added at pressures of, 1000 to 3000, for example 1400, 1600, 1800, 2000, 2200, or 2400 psi.

Other features and advantages of the invention will be apparent from the following detailed description, and from the claims.

### DETAILED DESCRIPTION

The invention provides foams made from biologically produced polyhydroxyalkanoate (PHA) polyesters. The foams have a good expansion ratio and densities comparable to current commercially-available foams. In certain embodiments, the foams include other polymers, including biodegradable or non-biodegradable polymers.

Methods for making such foams, and compositions (e.g., pellets) used to make the foams, are also provided.

In general, the foams include one or more polyhydroxyalkanoate polymers, one or more epoxy functional compounds and one or more foam cell nucleating agents. Optionally, the foams include a branching agent. In certain embodiment, the foams further include one or more nucleating agents.

Non-PHA polymers can also be included with the PHA polymer. The foam can be made by injection of a gas into the molten mixture of these ingredients. Alternatively, the composition used to make the foam can include a compound that generates a gas.

### Epoxy Function Compound

“Epoxy functional compound” as used herein is a compounds with two or more epoxide groups capable of increasing the melt strength of polyhydroxyalkanoate polymers by branching, e.g., end chain branching.

Such epoxy functional compounds can include epoxy-functional, styrene-acrylic polymers (such as, but not limited to, e.g., Joncryl ADR-4368 (BASF), or MP-40 (Kaneka)), acrylic and/or polyolefin copolymers and oligomers containing glycidyl groups incorporated as side chains (such as, but not limited to, e.g., LOTADER® (Arkema), poly(ethylene-glycidyl methacrylate-co-methacrylate)), and epoxidized oils (such as, but not limited to, e.g., epoxidized soybean, olive, linseed, palm, peanut, coconut, seaweed, cod liver oils, or mixtures thereof, e.g., Merginat® ESBO (Hobum, Hamburg, Germany) and Edenol® B 316 (Cognis, Dusseldorf, Germany)).

For example, reactive acrylics are used to increase the molecular weight of the polymer in the branched polymer compositions described herein. Such agents are sold commercially. BASF, for instance, sells multiple compounds under the trade name “Joncryl”, which are described in U.S. Pat. No. 6,984,694 to Blasius et al., “Oligomeric chain extenders for processing, post-processing and recycling of condensation polymers, synthesis, compositions and applications”, incorporated herein by reference in its entirety. One such compound is Joncryl ADR-4368CS, which is styrene glycidyl methacrylate and is discussed below. Another is MP-40(Kaneka). Such polymers are often used in plastic recycling (e.g., in recycling of polyethylene terephthalate) to increase the molecular weight (or to mimic the increase of molecular weight) of the polymer being recycled. Such polymers often have the general structure:

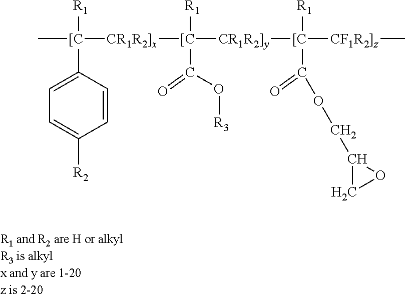

E.I. du Pont de Nemours & Company sells multiple reactive compounds under the trade name Elvaloy®, which are ethylene copolymers, such as acrylate copolymers, elastomeric terpolymers, and other copolymers. One such compound is Elvaloy PTW, which is a copolymer of ethylene-n-butyl acrylate and glycidyl methacrylate. Omnova sells similar compounds under the trade names “SX64053,” “SX64055,” and “SX64056.” Other entities also supply such compounds commercially.

Specific polyfunctional polymeric compounds with reactive epoxy functional groups are the styrene-acrylic copolymers and oligomers containing glycidyl groups incorporated as side chains. These materials are based on oligomers with styrene and acrylate building blocks that have glycidyl groups incorporated as side chains. A high number of epoxy groups per oligomer chain are used, for example 10, greater than 15, or greater than 20. These polymeric materials generally have a molecular weight greater than 3000, specifically greater than 4000, and more specifically greater than 6000. These are commercially available from Johnson Polymer, LLC (now owned by BASF) under the trade name JONCRYL, ADR 4368 material. Other types of polyfunctional polymer materials with multiple epoxy groups are acrylic and/or polyolefin copolymers and oligomers containing glycidyl groups incorporated as side chains. A further example of a such polyfunctional carboxy-reactive material is a co- or ter-polymer including units of ethylene and glycidyl methacrylate (GMA), available under the trade name LOTADER® resin, sold by Arkema. These materials can further comprise methacrylate units that are not glycidyl. An example of this type is poly(ethylene-glycidyl methacrylate-co-methacrylate).

Fatty acid esters or naturally occurring oils containing epoxy groups (epoxidized) can also be used. Examples of naturally occurring oils are olive oil, linseed oil, soybean oil, palm oil, peanut oil, coconut oil, seaweed oil, cod liver oil, or a mixture of these compounds. Particular preference is given to epoxidized soybean oil (e.g., Merginat® ESBO from Hobum, Hamburg, or Edenol® B 316 from Cognis, Dusseldorf), but others may also be used. Other examples include, poly(ethylene-co-methacrylate-coglycidyl methacrylate), ethylene-n-butyl acrylate-glycidyl methyl acetate copolymer. poly (ethylene-co-glycidylmethaacrylate) poly(ethylene-co-methaacrylate-coglycidyl methacrylate), poly(ethylene-glycidyl methacrylate-co-methacrylate ethylene/vinyl acetate/carbon monoxide copolymers, and ethylene/n-butyl acetate/carbon monoxide or combinations.

It was found that the epoxy-functional polymeric acrylics were a necessary addition. Not wishing to be bound by theory, it is believed that the functional acrylics raise the melt strength of the polymer, enabling the polymer to support a bubble.

The addition of talc and/or clay produces smaller, more uniform bubbles.

The density of the resulting foam also increases somewhat, but this can be ameliorated somewhat by controlling the blowing agent (gas). The resulting foam is less brittle, more uniform throughout, and would be more acceptable commercially.

In general, it has been found that the melt strength of the polyhydroxyalkanoate polymer must be maintained. Preferably the melt strength (G′) is about 500 Pa measured at 0.25 rad/s at 160° C.

In certain embodiments, a polyhydroxyalkanoate polymer and epoxy functional compound can be combined to make a cell nucleation composition. By “cell nucleation composition” is meant a composition that when combined with an amount of base polymer, provides the necessary constituents so that when the combination is processed on foam-making equipment, foam can be produced.

The cell nucleation composition can also include a cell nucleating compound, such as, but not limited to, talc and/or clay and/or another ingredient. The cell nucleating compound has the same meaning as a foam cell nucleating agent described herein. The cell nucleating compound provides cell nucleation foci, and can improve the quality of the foam produced when the cell nucleation composition is processed with the base polymer.

The cell nucleation composition can also include a polymer. The polymer can be of the same type that is later used as the base resin into which the cell nucleation composition is added. Alternatively, the polymer can be a different polymer. The addition of a polymer to the cell nucleation composition can be done to increase the ease of handling the composition, e.g., as a bulking agent.

In certain embodiments, a cell nucleation composition includes other ingredients as may be considered convenient by those of ordinary skill in the art of producing polymer foam.

The cell nucleation composition can be provided in any form that can be feasibly handled by foam processing equipment. For instance, the cell nucleation composition can be provided as a powder. The cell nucleation composition could also be provided as a liquid, if the components within the composition were mixed into a carrier liquid. Such a carrier liquid is preferably an additive that is normally used in polymer processing. For instance, the carrier liquid can be Citraflex A4.

Preferably, the cell nucleation composition is provided as a cell nucleation pellet. For instance, the cell nucleation composition can include a polymer, as discussed above, and the cell nucleation composition, with its added polymer, can be processed into pellets or some other solid form as is commonly used in the polymer foam-making industry. For instance, the cell nucleation composition can be made into special-purpose pellets to be added to a base polymer resin and then processed on foam-making equipment to make polymer foam.

### Foam Cell Nucleating Agents

Foam cell nucleating agents as used herein are compounds that allow the foam cell to develop. These compositions include talc and clay. An example of a suitable talc is talc, Flextalc 610D. An example of a suitable clay is SCPX3016.

Clays are also useful as foam cell nucleating agents. Another example is, nanoclay or organically modified clay. There are several types of clays used in polymeric compositions, including cationic or medium or high cation exchange capacity. The cation exchange capacity is generally reported as the number of milliequivalents of exchangeable base which can be exchanged per 100 grams of clay. The cation exchange capacity varies from about 50 to about 150 depending on the type of clay. Examples of clays which can be organically modified include sepiolite, attapulgite, montmorillonites, bentonites, saponite and nentronite.

Organically modified clays are known in the art and are also described in U.S. Pat. No. 2,531,440. Examples include montmorillonite clay modified with ternary or quaternary ammonunium salts. Nanoclays are commercially available from Southern Clay Products, Inc. of Gonzales, Tex., USA (such as, but not limited to, Cloisite®NA⁺ (a natural montmorillonite), Cloisite® 93A & 30B (a natural montmorillonite modified with ternary ammonium salts), and Cloisite® 10A, 15A, 20A, and 25A (a natural montmorillonite modified with quaternary ammonium salts).

Montmorillonite clay is the most common member of the smectite family of nanoclays. Smectites have a unique morphology, featuring one dimension in the nanometer range. The montmorillonite clay particle is often called a platelet, which is a sheet-like structure where the dimensions in two directions far exceed the particle's thickness. The length and breadth of the particles range from 1.5 microns down to a few tenths of a micrometer. However, the thickness is only about a nanometer. These dimensions result in extremely high average aspect ratios (on the order of 200-500). Moreover, the very small size and thickness mean that a single gram of clay can contain over a million individual particles.

The clay initially comprises agglomerates of platelet layers. Nanoclay becomes commercially useful if processed into an intercalate, which separates (exfoliates) the platelets in the agglomerates. In an intercalate, the clay is mixed with an intercalate under conditions which cause the platelets to separate and the intercalate to enter into the spaces between the platelets. The intercalant is often an organic or semi-organic chemical capable of entering the montmorillonite clay gallery and bonding to the surface of the platelets. An intercalate is therefore a clay-chemical complex wherein the clay gallery spacing has increased, due to the process of surface modification by the substance (the intercalant). Under the proper conditions of temperature and shear, the platelet agglomerates are capable of exfoliating (separating), allowing the intercalant to enter between them, separating and exfoliating them.

The platelets can be exfoliated (separated) by a number of processes. In one exfoliation procedure, described in U.S. Pat. No. 6,699,320, the process utilizes a dispersant to enter between the layers of clay platelets and separate them. In this process, the clay is mixed with a dispersant (e.g., castor wax), and then heated in the barrel of an extruder to a temperature above the melting point of the dispersant (e.g., 82° C.-104° C. in the case of castor wax). The heated mixture is then agitated, e.g., with a deep flighted screw. This heating and agitating disperses the platelet layers and delaminates the platelets from neighboring layers, by allowing molecules of dispersant to enter between the layers. The layers are considered “exfoliated” when the separation between the platelet layers is large enough such that there is no longer sufficient attraction between layers to cause uniform spacing between the layers.

In the process described in U.S. Pat. No. 6,699,320, the screw within the extruder moves the clay-wax mixture out of an extrusion die opening in the form of a hot slurry. Two chilled chrome-plated rollers are then used to calender the mixture to a predetermined thickness that is determined by the spacing between the rollers. The mixture is cooled to solidify the wax. The clay-wax mixture is then scraped off the rollers and falls as flakes onto a conveyer belt. The flakes can be tumbled to further reduce their size, and used immediately, or stored.

Because of the very small size of the clay particles, nanoclays are difficult to handle, and may pose health risks. They are therefore sometimes processed into “masterbatches,” in which the clay is dispersed into a polymer resin at a high concentration. Portions of the masterbatch are then added in measured quantities to polymer that does not contain nanoclay, to produce a polymer containing a precise amount of the nanoclay.

One montmorillonite clay is Cloisite® 25A, which can be obtained from Southern Clay Products of Gonzales, Tex., USA. A typical dry particle size distribution of Cloisite® 25A is 10% less than 2 microns, 50% less than 6 microns, and 90% less than 13 microns.

Other nanoclays are identified in U.S. Pat. No. 6,414,070 (Kausch et al.), which is incorporated herein by reference in its entirety, and PCT Patent Publications WO 00/66657 and WO 00/68312.

### Polyhydroxyalkanoates (PHAs)

Polyhydroxyalkanoates are biological polyesters synthesized by a broad range of natural and genetically engineered bacteria as well as genetically engineered plant crops (Braunegg et al., (1998), J. Biotechnology 65: 127-161; Madison and Huisman, 1999, Microbiology and Molecular Biology Reviews, 63: 21-53; Poirier, 2002, Progress in Lipid Research 41: 131-155). These polymers are biodegradable thermoplastic materials, produced from renewable resources, with the potential for use in a broad range of industrial applications (Williams & Peoples, CHEMTECH 26:38-44 (1996)). Useful microbial strains for producing PHAs, include Alcaligenes eutrophus (renamed as Ralstonia eutropha), Alcaligenes latus, Azotobacter, Aeromonas, Comamonas, Pseudomonads, and genetically engineered organisms including genetically engineered microbes such as Pseudomonas, Ralstonia and Escherichia coli.

In general, a PHA is formed by enzymatic polymerization of one or more monomer units inside a living cell. Over 100 different types of monomers have been incorporated into the PHA polymers (Steinbüchel and Valentin, 1995, FEMS Microbiol. Lett. 128; 219-228. Examples of monomer units incorporated in PHAs include 2-hydroxybutyrate, lactic acid, glycolic acid, 3-hydroxybutyrate (hereinafter referred to as HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HHep), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

In some embodiments, the PHA in the methods for preparing foam and foam compositions is a homopolymer (all monomer units are the same). Examples of PHA homopolymers include poly 3-hydroxyalkanoates (e.g., poly 3-hydroxypropionate (hereinafter referred to as P3HP), poly 3-hydroxybutyrate (hereinafter referred to as PHB) and poly 3-hydroxyvalerate), poly 4-hydroxyalkanoates (e.g., poly 4-hydroxybutyrate (hereinafter referred to as P4HB), or poly 4-hydroxyvalerate (hereinafter referred to as P4HV)) and poly 5-hydroxyalkanoates (e.g., poly 5-hydroxyvalerate (hereinafter referred to as P5HV)).

In certain embodiments, the starting PHA can be a copolymer (contain two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as PHB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV). By selecting the monomer types and controlling the ratios of the monomer units in a given PHA copolymer a wide range of material properties can be achieved. Although examples of PHA copolymers having two different monomer units have been provided, the PHA can have more than two different monomer units (e.g., three different monomer units, four different monomer units, five different monomer units, six different monomer units). An example of a PHA having 4 different monomer units would be PHB-co-3HH-co-3HO-co-3HD or PHB-co-3-HO-co-3HD-co-3HDd (these types of PHA copolymers are hereinafter referred to as PHB3HX). Typically where the PHB3HX has 3 or more monomer units the 3HB monomer is at least 70% by weight of the total monomers, preferably 85% by weight of the total monomers, most preferably greater than 90% by weight of the total monomers for example 92%, 93%, 94%, 95%, 96% by weight of the copolymer and the HX comprises one or more monomers selected from 3HH, 3HO, 3HD, 3HDd.

The homopolymer (all monomer units are identical) PHB and 3-hydroxybutyrate copolymers (PHB3HP, PHB4HB, PHB3HV, PHB4HV, PHB5HV, PHB3HH P, hereinafter referred to as PHB copolymers) containing 3-hydroxybutyrate and at least one other monomer are of particular interest for commercial production and applications. It is useful to describe these copolymers by reference to their material properties as follows. Type 1 PHB copolymers typically have a glass transition temperature (Tg) in the range of 6° C. to −10° C., and a melting temperature T_{M} of between 80° C. to 180° C. Type 2 PHB copolymers typically have a Tg of −20° C. to −50° C. and Tm of 55° C. to 90° C.

Preferred Type 1 PHB copolymers have two monomer units with have a majority of their monomer units being 3-hydroxybutyrate monomer by weight in the copolymer, for example, greater than 78% 3-hydroxybutyrate monomer. Preferred PHB copolymers for this invention are biologically produced from renewable resources and are selected from the following group of PHB copolymers:
PHB3HV is a Type 1 PHB copolymer where the 3HV content is in the range of 3% to 22% by weight of the polymer and preferably in the range of 4% to 15% by weight of the copolymer for example: 4% 3HV; 5% 3HV; 6% 3HV; 7% 3HV; 8% 3HV; 9% 3HV; 10% 3HV; 11% 3HV; 12% 3HV; 13% 3HV; 14% 3HV; 15% 3HV;
PHB3HP is a Type 1 PHB copolymer where the 3HP content is in the range of 3% to 15% by weight of the copolymer and preferably in the range of 4% to 15% by weight of the copolymer for example: 4% 3HP; 5% 3HP; 6% 3HP; 7% 3HP; 8% 3HP; 9% 3HP; 10% 3HP; 11% 3HP; 12% 3HP. 13% 3HP; 14% 3HP; 15% 3HP.
PHB4HB is a Type 1 PHB copolymer where the 4HB content is in the range of 3% to 15% by weight of the copolymer and preferably in the range of 4% to 15% by weight of the copolymer for example: 4% 4HB; 5% 4HB; 6% 4HB; 7% 4HB; 8% 4HB; 9% 4HB; 10% 4HB; 11% 4HB; 12% 4HB; 13% 4HB; 14% 4HB; 15% 4HB.
PHB4HV is a Type 1 PHB copolymer where the 4HV content is in the range of 3% to 15% by weight of the copolymer and preferably in the range of 4% to 15% by weight of the copolymer for example: 4% 4HV; 5% 4HV; 6% 4HV; 7% 4HV; 8% 4HV; 9% 4HV; 10% 4HV; 11% 4HV; 12% 4HV; 13% 4HV; 14% 4HV; 15% 4HV.
PHB5HV is a Type 1 PHB copolymer where the 5HV content is in the range of 3% to 15% by weight of the copolymer and preferably in the range of 4% to 15% by weight of the copolymer for example: 4% 5HV; 5% 5HV; 6% 5HV; 7% 5HV; 8% 5HV; 9% 5HV; 10% 5HV; 11% 5HV; 12% 5HV; 13% 5HV; 14% 5HV; 15% 5HV.
PHB3HH is a Type 1 PHB copolymer where the 3HH content is in the range of 3% to 15% by weight of the copolymer and preferably in the range of 4% to 15% by weight of the copolymer for example: 4% 3HH; 5% 3HH; 6% 3HH; 7% 3HH; 8% 3HH; 9% 3HH; 10% 3HH; 11% 3HH; 12% 3HH; 13% 3HH; 14% 3HH; 15% 3HH;
PHB3HX is a Type 1 PHB copolymer where the 3HX content is comprised of 2 or more monomers selected from 3HH, 3HO, 3HD and 3HDd and the 3HX content is in the range of 3% to 12% by weight of the copolymer and preferably in the range of 4% to 10% by weight of the copolymer for example: 4% 3HX; 5% 3HX; 6% 3HX; 7% 3HX; 8% 3HX; 9% 3HX; 10% 3HX by weight of the copolymer.
Type 2 PHB copolymers have a 3HB content of between 80% and 5% by weight of the copolymer, for example 80%, 75%, 70%, 65%, 60%, 55%, 50%, 45%, 40%, 35%, 30%, 25%, 20%, 5%, 10% by weight of the copolymer.
PHB4HB is a Type 2 PHB copolymer where the 4HB content is in the range of 20% to 60% by weight of the copolymer and preferably in the range of 25% to 50% by weight of the copolymer for example: 25% 4HB; 30% 4HB; 35% 4HB; 40% 4HB; 45% 4HB; 50% 4HB by weight of the copolymer.
PHB5HV is a Type 2 PHB copolymer where the 5HV content is in the range of 20% to 60% by weight of the copolymer and preferably in the range of 25% to 50% by weight of the copolymer for example: 25% 5HV; 30% 5HV; 35% 5HV; 40% 5HV; 45% 5HV; 50% 5HV by weight of the copolymer.
PHB3HH is a Type 2 PHB copolymer where the 3HH is in the range of 35% to 95% by weight of the copolymer and preferably in the range of 40% to 80% by weight of the copolymer for example: 40% 3HH; 45% 3HH; 50% 3HH; 60% 3HH; 65% 3HH; 70% 3HH; 75% 3HH; 80% 3HH by weight of the copolymer.
PHB3HX is a Type 2 PHB copolymer where the 3HX content is comprised of 2 or more monomers selected from 3HH, 3HO, 3HD and 3HDd and the 3HX content is in the range of 30% to 95% by weight of the copolymer and preferably in the range of 35% to 90% by weight of the copolymer for example: 35% 3HX; 40% 3HX; 45% 3HX 50% 3HX; 55% 3HX 60% 3HX; 65% 3HX 70% 3HX; 75% 3HX 80% 3HX; 85% 3HX 90% 3HX by weight of the copolymer.

PHAs for use in the methods, compositions and pellets described in this invention are selected from: PHB or a Type 1 PHB copolymer; a PHA blend of PHB with a Type 1 PHB copolymer where the PHB content by weight of PHA in the PHA blend is in the range of 5% to 95% by weight of the PHA in the PHA blend; a PHA blend of PHB with a Type 2 PHB copolymer where the PHB content by weight of the PHA in the PHA blend is in the range of 5% to 95% by weight of the PHA in the PHA blend; a PHA blend of a Type 1 PHB copolymer with a different Type 1 PHB copolymer and where the content of the first Type 1 PHB copolymer is in the range of 5% to 95% by weight of the PHA in the PHA blend; a PHA blend of a Type 1 PHB copolymer with a Type 2 PHA copolymer where the content of the Type 1 PHB copolymer is in the range of 30% to 95% by weight of the PHA in the PHA blend; a PHA blend of PHB with a Type 1 PHB copolymer and a Type 2 PHB copolymer where the PHB content is in the range of 10% to 90% by weight of the PHA in the PHA blend, where the Type 1 PHB copolymer content is in the range of 5% to 90% by weight of the PHA in the PHA blend and where the Type 2 PHB copolymer content is in the range of 5% to 90% by weight of the PHA in the PHA blend.

The PHA blend of PHB with a Type 1 PHB copolymer is a blend of PHB with PHB3HP where the PHB content in the PHA blend is in the range of 5% to 90% by weight of the PHA in the PHA blend and the 3HP content in the PHB3HP is in the range of 7% to 15% by weight of the PHB3HP.

The PHA blend of PHB with a Type 1 PHB copolymer is a blend of PHB with PHB3HV where the PHB content of the PHA blend is in the range of 5% to 90% by weight of the PHA in the PHA blend and the 3HV content in the PHB3HV is in the range of 4% to 22% by weight of the PHB3HV.

The PHA blend of PHB with a Type 1 PHB copolymer is a blend of PHB with PHB4HB where the PHB content of the PHA blend is in the range of 5% to 90% by weight of the PHA in the PHA blend and the 4HB content in the PHB4HB is in the range of 4% to 15% by weight of the PHB4HB.

The PHA blend of PHB with a Type 1 PHB copolymer is a blend of PHB with PHB4HV where the PHB content of the PHA blend is in the range of 5% to 90% by weight of the PHA in the PHA blend and the 4HV content in the PHB4HV is in the range of 4% to 15% by weight of the PHB4HV.

The PHA blend of PHB with a Type 1 PHB copolymer is a blend of PHB with PHB5HV where the PHB content of the PHA blend is in the range of 5% to 90% by weight of the PHA in the PHA blend and the 5HV content in the PHB5HV is in the range of 4% to 15% by weight of the PHB5HV.

The PHA blend of PHB with a Type 1 PHB copolymer is a blend of PHB with PHB3HH where the PHB content of the PHA blend is in the range of 5% to 90% by weight of the PHA in the PHA blend and the 3HH content in the PHB3HH is in the range of 4% to 15% by weight of the PHB3HH.

The PHA blend of PHB with a Type 1 PHB copolymer is a blend of PHB with PHB3HX where the PHB content of the PHA blend is in the range of 5% to 90% by weight of the PHA in the PHA blend and the 3HX content in the PHB3HX is in the range of 4% to 15% by weight of the PHB3HX.

The PHA blend is a blend of a Type 1 PHB copolymer selected from the group PHB3HV, PHB3HP, PHB4HB, PHBV, PHV4HV, PHB5HV, PHB3HH and PHB3HX with a second Type 1 PHB copolymer which is different from the first Type 1 PHB copolymer and is selected from the group PHB3HV, PHB3HP, PHB4HB, PHBV, PHV4HV, PHB5HV, PHB3HH and PHB3HX where the content of the First Type 1 PHB copolymer in the PHA blend is in the range of 10% to 90% by weight of the total PHA in the blend.

The PHA blend of PHB with a Type 2 PHB copolymer is a blend of PHB with PHB4HB where the PHB content in the PHA blend is in the range of 30% to 95% by weight of the PHA in the PHA blend and the 4HB content in the PHB4HB is in the range of 20% to 60% by weight of the PHB4HB.

The PHA blend of PHB with a Type 2 PHB copolymer is a blend of PHB with PHB5HV where the PHB content in the PHA blend is in the range of 30% to 95% by weight of the PHA in the PHA blend and the 5HV content in the PHB5HV is in the range of 20% to 60% by weight of the PHB5HV.

The PHA blend of PHB with a Type 2 PHB copolymer is a blend of PHB with PHB3HH where the PHB content in the PHA blend is in the range of 35% to 95% by weight of the PHA in the PHA blend and the 3HH content in the PHB3HH is in the range of 35% to 90% by weight of the PHB3HX.

The PHA blend of PHB with a Type 2 PHB copolymer is a blend of PHB with PHB3HX where the PHB content in the PHA blend is in the range of 30% to 95% by weight of the PHA in the PHA blend and the 3HX content in the PHB3HX is in the range of 35% to 90% by weight of the PHB3HX.

The PHA blend is a blend of PHB with a Type 1 PHB copolymer and a Type 2 PHB copolymer where the PHB content in the PHA blend is in the range of 10% to 90% by weight of the PHA in the PHA blend, the Type 1 PHB copolymer content of the PHA blend is in the range of 5% to 90% by weight of the PHA in the PHA blend and the Type 2 PHB copolymer content in the PHA blend is in the range of 5% to 90% by weight of the PHA in the PHA blend.

For example a PHA blend can have a PHB content in the PHA blend in the range of 10% to 90% by weight of the PHA in the PHA blend, a PHB3HV content in the PHA blend in the range 5% to 90% by weight of the PHA in the PHA blend, where the 3HV content in the PHB3HV is in the range of 3% to 22% by weight of the PHB3HV, and a PHBHX content in the PHA blend in the range of 5% to 90% by weight of the PHA in the PHA blend where the 3HX content in the PHBHX is in the range of 35% to 90% by weight of the PHBHX.

For example a PHA blend can have a PHB content in the PHA blend in the range of 10% to 90% by weight of the PHA in the PHA blend, a PHB3HV content in the PHA blend in the range 5% to 90% by weight of the PHA in the PHA blend, where the 3HV content in the PHB3HV is in the range of 3% to 22% by weight of the PHB3HV, and a PHB4HB content in the PHA blend in the range of 5% to 90% by weight of the PHA in the PHA blend where the 4HB content in the PHB4HB is in the range of 20% to 60% by weight of the PHB4HB.

For example a PHA blend can have a PHB content in the PHA blend in the range of 10% to 90% by weight of the PHA in the PHA blend, a PHB3HV content in the PHA blend in the range 5% to 90% by weight of the PHA in the PHA blend, where the 3HV content in the PHB3HV is in the range of 3% to 22% by weight of the PHB3HV, and a PHB5HV content in the PHA blend in the range of 5% to 90% by weight of the PHA in the PHA blend where the 5HV content in the PHB5HV is in the range of 20% to 60% by weight of the PHB5HV.

For example a PHA blend can have a PHB content in the PHA blend in the range of 10% to 90% by weight of the PHA in the PHA blend, a PHB4HB content in the PHA blend in the range 5% to 90% by weight of the PHA in the PHA blend, where the 4HB content in the PHB4HB is in the range of 4% to 15% by weight of the PHB4HB, and a PHB4HB content in the PHA blend in the range of 5% to 90% by weight of the PHA in the PHA blend where the 4HB content in the PHB4HB is in the range of 20% to 60% by weight of the PHB4HB.

For example a PHA blend can have a PHB content in the PHA blend in the range of 10% to 90% by weight of the PHA in the PHA blend, a PHB4HB content in the PHA blend in the range 5% to 90% by weight of the PHA in the PHA blend, where the 4HB content in the PHB4HB is in the range of 4% to 15% by weight of the PHB4HB, and a PHB5HV content in the PHA blend in the range of 5% to 90% by weight of the PHA in the PHA blend and where the 5HV content in the PHB5HV is in the range of 30% to 90% by weight of the PHB5HV.

For example a PHA blend can have a PHB content in the PHA blend in the range of 10% to 90% by weight of the PHA in the PHA blend, a PHB4HB content in the PHA blend in the range 5% to 90% by weight of the PHA in the PHA blend, where the 4HB content in the PHB4HB is in the range of 4% to 15% by weight of the PHB4HB, and a PHB3HX content in the PHA blend in the range of 5% to 90% by weight of the PHA in the PHA blend and where the 3HX content in the PHB3HX is in the range of 35% to 90% by weight of the PHB3HX.

For example a PHA blend can have a PHB content in the PHA blend in the range of 10% to 90% by weight of the PHA in the PHA blend, a PHB4HV content in the PHA blend in the range 5% to 90% by weight of the PHA in the PHA blend, where the 4HV content in the PHB4HV is in the range of 3% to 15% by weight of the PHB4HV, and a PHB5HV content in the PHA blend in the range of 5% to 90% by weight of the PHA in the PHA blend where the 5HV content in the PHB5HV is in the range of 30% to 90% by weight of the PHB5HV.

For example a PHA blend can have a PHB content in the PHA blend in the range of 10% to 90% by weight of the PHA in the PHA blend, a PHB3HH content in the PHA blend in the range 5% to 90% by weight of the PHA in the PHA blend, where the 3HH content in the PHB3HH is in the range of 3% to 15% by weight of the PHB3HH, and a PHB4HB content in the PHA blend in the range of 5% to 90% by weight of the PHA in the PHA blend where the 4HB content in the PHB4HB is in the range of 20% to 60% by weight of the PHB4HB.

For example a PHA blend can have a PHB content in the PHA blend in the range of 10% to 90% by weight of the PHA in the PHA blend, a PHB3HH content in the PHA blend in the range 5% to 90% by weight of the PHA in the PHA blend, where the 3HH content in the PHB3HH is in the range of 3% to 15% by weight of the PHB3HH, and a PHB5HV content in the PHA blend in the range of 5% to 90% by weight of the PHA in the PHA blend where the 5HV content in the PHB5HV is in the range of 20% to 60% by weight of the PHB5HV.

For example a PHA blend can have a PHB content in the PHA blend in the range of 10% to 90% by weight of the PHA in the PHA blend, a PHB3HH content in the PHA blend in the range 5% to 90% by weight of the PHA in the PHA blend, where the 3HH content in the PHB3HH is in the range of 3% to 15% by weight of the PHB3HH, and a PHB3HX content in the PHA blend in the range of 5% to 90% by weight of the PHA in the PHA blend where the 3HX content in the PHB3HX is in the range of 35% to 90% by weight of the PHB3HX.

For example a PHA blend can have a PHB content in the PHA blend in the range of 10% to 90% by weight of the PHA in the PHA blend, a PHB3HX content in the PHA blend in the range 5% to 90% by weight of the PHA in the PHA blend, where the 3HX content in the PHB3HX is in the range of 3% to 12% by weight of the PHB3HX, and a PHB3HX content in the PHA blend in the range of 5% to 90% by weight of the PHA in the PHA blend where the 3HX content in the PHB3HX is in the range of 35% to 90% by weight of the PHB3HX.

For example a PHA blend can have a PHB content in the PHA blend in the range of 10% to 90% by weight of the PHA in the PHA blend, a PHB3HX content in the PHA blend in the range 5% to 90% by weight of the PHA in the PHA blend, where the 3HX content in the PHB3HX is in the range of 3% to 12% by weight of the PHB3HX, and a PHB4HB content in the PHA blend in the range of 5% to 90% by weight of the PHA in the PHA blend where the 4HB content in the PHB4HB is in the range of 20% to 60% by weight of the PHB4HB.

For example a PHA blend can have a PHB content in the PHA blend in the range of 10% to 90% by weight of the PHA in the PHA blend, a PHB3HX content in the PHA blend in the range 5% to 90% by weight of the PHA in the PHA blend, where the 3HX content in the PHB3HX is in the range of 3% to 12% by weight of the PHB3HX, and a PHB5HV content in the PHA blend in the range of 5% to 90% by weight of the PHA in the PHA blend where the 5HV content in the PHB5HV is in the range of 20% to 60% by weight of the PHB5HV.

The PHA blend is a blend as disclosed in U.S. Pub. App. No. 2004/0220355, by Whitehouse, published Nov. 4, 2004, which is incorporated herein by reference in its entirety.

Microbial systems for producing the PHB copolymer PHBV are disclosed in U.S. Pat. No. 4,477,654 to Holmes. PCT WO 02/08428, by Skraly and Sholl describes useful systems for producing the PHB copolymer PHB4HB. Useful processes for producing the PHB copolymer PHB3HH have been described (Lee et. al., 2000, Biotechnology and Bioengineering, 67: 240-244; Park et al., 2001, Biomacromolecules, 2: 248-254). Processes for producing the PHB copolymers PHB3HX have been described by Matsusaki et. al., (Biomacromolecules, 2000, 1: 17-22).

In determining the molecular weight techniques such as gel permeation chromatography (GPC) can be used. In the methodology, a polystyrene standard is utilized. The PHA can have a polystyrene equivalent weight average molecular weight (in daltons) of at least 500, at least 10,000, or at least 50,000 and/or less than 2,000,000, less than 1,000,000, less than 1,500,000, and less than 800,000. In certain embodiments, preferably, the PHAs generally have a weight-average molecular weight in the range of 100,000 to 700,000. For example, the molecular weight range for PHB and Type 1 PHB copolymers for use in this application are in the range of 400,000 daltons to 1.5 million daltons as determined by GPC method and the molecular weight range for Type 2 PHB copolymers for use in the application 100,000 to 1.5 million daltons.

In certain embodiments, the branched PHA can have a linear equivalent weight average molecular weight of from about 150,000 Daltons to about 500,000 Daltons and a polydispersity index of from about 2.5 to about 8.0. As used herein, weight average molecular weight and linear equivalent weight average molecular weight are determined by gel permeation chromatography, using, e.g., chloroform as both the eluent and diluent for the PHA samples. Calibration curves for determining molecular weights are generated using linear polystyrenes as molecular weight standards and a ‘log MW vs elution volume’ calibration method.

### Branched Polyhydroxyalkanoates

The term “branched PHA” refers to a PHA with branching of the chain and/or cross-linking of two or more chains. Branching on side chains is also contemplated. Branching can be accomplished by various methods. Polyhydroxyalkanoate polymer described above can be branched by branching agents by free-radical-induced cross-linking of the polymer. In certain embodiment, the PHA is branched prior to combination in the method. In other embodiments, the PHA reacted with peroxide in the methods of the invention. The branching increases the melt strength of the polymer. Polyhydroxyalkanoate polymers can be branched in any of the ways described in U.S. Pat. Nos. 6,620,869, 7,208,535, 6,201,083, 6,156,852, 6,248,862, 6,201,083 and 6,096,810 all of which are incorporated herein by reference in their entirety.

### Branching Agents

The branching agents, also referred to a free radical initiator, for use in the compositions and method described herein include organic peroxides. Peroxides are reactive molecules, and can react with linear PHA molecules or previously branched PHA by removing a hydrogen atom from the polymer backbone, leaving behind a radical. PHA molecules having such radicals on their backbone are free to combine with each other, creating branched PHA molecules. Branching agents are selected from any suitable initiator known in the art, such as peroxides, azo-dervatives (e.g., azo-nitriles), peresters, and peroxycarbonates. Suitable peroxides for use in the present invention include, but are not limited to, organic peroxides, for example dialkyl organic peroxides such as 2,5-dimethyl-2,5-di(t-butylperoxy)hexane, 2,5-bis(t-butylperoxy)-2,5-dimethylhexane (available from Akzo Nobel as TRIGANOX 101), 2,5-dimethyl-di(t-butylperoxy)hexyne-3, di-t-butyl peroxide, dicumyl peroxide, benzoyl peroxide, di-t-amyl peroxide, t-amylperoxy-2-ethylhexylcarbonate (TAEC), t-butyl cumyl peroxide, n-butyl-4,4-bis(t-butylperoxy)valerate, 1,1-di(t-butylperoxy)-3,3,5-trimethyl-cyclohexane, 1,1-bis(t-butylperoxy)-3,3,5-trimethylcyclohexane (CPK), 1,1-di(t-butylperoxy)cyclohexane, 1,1-di(t-amylperoxy)-cyclohexane, 2,2-di(t-butylperoxy)butane, ethyl-3,3-di(t-butylperoxy)butyrate, 2,2-di(t-amylperoxy)propane, ethyl-3,3-di(t-amylperoxy)butyrate, t-butylperoxy-acetate, t-amylperoxyacetate, t-butylperoxybenzoate, t-amylperoxybenzoate, di-t-butyldiperoxyphthalate, and the like. Combinations and mixtures of peroxides can also be used. Examples of free radical initiators include those mentioned herein, as well as those described in, e.g., Polymer Handbook, 3^{rd} Ed., J. Brandrup & E. H. Immergut, John Wiley and Sons, 1989, Ch. 2. Irradiation (e.g., e-beam or gamma irradiation) can also be used to generate PHA branching.

The efficiency of branching and crosslinking of the polymer(s) can also be significantly enhanced by the dispersion of organic peroxides in a cross-linking agent, such as a polymerizable (i.e., reactive) plasticizers. The polymerizable plasticizer should contain a reactive functionality, such as a reactive unsaturated double bond, which increases the overall branching and crosslinking efficiency.

As discussed above, when peroxides decompose, they form very high energy radicals that can extract a hydrogen atom from the polymer backbone. These radicals have short half-lives, thereby limiting the population of branched molecules that is produced during the active time period.

### Biodegradable Aromatic/Aliphatic Polyesters

Aromatic polyesters, which are not biodegradable, are synthesized by the polycondensation of aliphatic diols and aromatic dicarboxylic acids. The aromatic ring is resistant to hydrolysis, preventing biodegradability. Polyethylene terephthalate (PET) and polybutylene terephthalate (PBT) are formed by the polycondensation of aliphatic glycols and terephthalic acid. The biodegradability of aromatic polyesters can be modified by the addition of monomers that are not resistant to hydrolysis, aliphatic diol or diacid groups. The addition of such hydrolysis-sensitive monomers creates weak spots for hydrolysis to occur.

Aromatic/aliphatic polyesters are also made by polycondensation of aliphatic diols, but with a mixture of aromatic and aliphatic dicarboxylic acids. For instance, modification of PBT by addition of aliphatic dicarboxylic acids can produce polybutylene succinate terephthalate (PBST) (butane diol as the aliphatic diol and succinic and terephthalic acid). Another example is the family of polyesters sold under the trade name Biomax™ (du Pont), the members of which are polymerized from PET and a variety of aliphatic acid monomers such as dimethylglutarate and diethylene glycol. In the synthesis of polybutylene adipate terephthalate (PBAT), butanediol is the diol, and the acids are adipic and terephthalic acids. Commercial examples include Ecoflex (BASF) and Eastar Bio (Novamont). Ecoflex has a melt temperature (Tm) of about 110° C. to about 120° C., as measured by differential scanning calorimetry (DSC). In preferred embodiments, the biodegradable polymers described in U.S. Pat. Nos. 6,018,004; 6,114,042; 6,201,034; and 6,303,677, incorporated by reference, are used in the compositions and methods described herein.

Biodegradable polymers therefore include polyesters containing aliphatic components. Among the polyesters are ester polycondensates containing aliphatic constituents or poly(hydroxycarboxylic) acids. In certain embodiments, the ester polycondensates include diacids/diol aliphatic polyesters such as polybutylene succinate, polybutylene succinate co-adipate, aliphatic/aromatic polyesters such as terpolymers made of butylenes diol, adipic acid and terephtalic acid.

Examples of biodegradable aromatic/aliphatic polyesters therefore include, but are not limited to, various copolyesters of PET and PBT with aliphatic diacids or diols incorporated into the polymer backbone to render the copolyesters biodegradable or compostable; and various aliphatic polyesters and copolyesters derived from dibasic acids, e.g., succinic acid, glutaric acid, adipic acid, sebacic acid, azealic acid, or their derivatives (e.g., alkyl esters, acid chlorides, or their anhydrides) and dihydroxy compounds (diols) such as C₂-C₆ alkanediols and C₅-C₁₀ cycloalkanediols, such as ethylene glycol, propylene glycol, 1,4-butanediol, 1,6 hexanediol. In other embodiments, the diol is 1,4 cyclohexanedimethanol. In preferred embodiments, the dihydroxy compound is ethylene glycol, or 1,4-butanediol. Biodegradable diols are preferred in certain embodiments.

Examples of a suitable commercially available diacid/diol aliphatic polyesters are the polybutylene succinate (PBS) and polybutylene succinate/adipate (PBSA) copolymers BIONOLLE 1000 and BIONOLLE 3000 from the Showa High Polymer Company, Ltd. (Tokyo, Japan). An example of a suitable commercially available aromatic/aliphatic copolyester is the poly(tetrabutylene adipate-co-terephthalate) sold as EASTAR BIO Copolyester from Novamont, formerly Eastman Chemical or ECOFLEX from BASF.

Additionally, carprolactone polyesters (e.g., CAPA® polyesters (produced by Perstorp, formerly from Solvay or TONE polyesters produced by Dow Chemical) and the like), can be useful in the compositions and methods described herein. These polymers are produced by a ring opening addition polymerization reaction rather than the condensation polymerization reaction used for other polyesters. The poly(hydroxycarboxylic) acids for use in the methods and compositions include lactic acid based homopolymers and copolymers, polyhydroxybutyrate (PHB), or other polyhydroxyalkanoate homopolymers and copolymers. Such polyhydroxyalkanoates include copolymers of PHB with higher chain length monomers, such as C₆-C₁₂, and higher. The biodegradable aromatic/aliphatic polyester can be a co-polyester. It can also itself be a blend of such polyesters or co-polyesters.

### Branched Polyhydroxyalkanoates

Polyhydroxyalkanoate polymer described above can be branched by branching agents by free-radical-induced cross-linking of the polymer. In certain embodiment, the PHA is branched prior to combination in the method. In other embodiments, the PHA reacted with peroxide in the methods of the invention. The branching increases the melt strength of the polymer. Polyhydroxyalkanoate polymers can be branched in any of the ways described in U.S. U.S. Pat. Nos. 6,620,869, 7,208,535, 6,201,083, 6,156,852, 6,248,862, 6,201,083, and 6,096,810 all of which are incorporated herein by reference in their entirety.

### Process of Preparing Foam

The density of the resulting foam also increases somewhat, but this can be ameliorated somewhat by controlling the blowing agent (gas). The resulting foam is less brittle, more uniform throughout, and would be more acceptable commercially.

In general, it has been found that the melt strength of the polyhydroxyalkanoate polymer must be maintained. Preferably the melt strength (G′) is about 500 Pa measured at 0.25 rad/sec at 160° C.

If the melt strength is high, then the gas concentration should be lower, preferably about 3%. Higher rates, e.g., 10% to 15%, increases the initial expansion out of the die, but the foam tends to collapse before it can cool and crystallize.

It is also preferable to set the second extruder at the higher than expected temperature, e.g., 165° C. (which is closer to the melt temperature of the polymer), rather than 145° C.

The biodegradable foams described in the present invention can be produced using any art-known method for producing foam.

For instance, the foam can be made on a tandem extruder foam line. In the production of foam, it is common in the art to place two extruders in series. The first extruder melts the polymer and dissolves the foaming agent into the polymer mix. The second extruder cools the mixture, making it more viscous and partially setting up the material, and then extruding the foam.

It is generally preferred that a polyhydroxyalkanoate to be foamed have a sufficiently high melt viscosity to hold a foamed shape sufficiently long for the polymer to solidify to form the final foamed article. A sufficient melt viscosity can be achieved by raising the viscosity of the polymer using the methods described herein. A branching agent can also be incorporated into the polyester as described in U.S. Pat. Nos. 4,132,707, 4,145,466, 4,999,388, 5,000,991, 5,110,844, 5,128,383, and 5,134,028. The polymer can also contain a chain extension agent, such as a dianhydride or a polyepoxide, which is typically added during the foaming process.

The polyhydroxyalkanoate polymers can be foamed by a wide variety of methods, including the injection of an inert gas such as nitrogen or carbon dioxide into the melt during extrusion or molding operations. Alternatively, inert hydrocarbon gases such as methane, ethane, propane, butane, and pentane, or chlorofluorocarbons, hydrochlorofluorocarbons, hydrofluorocarbons, can be used. Another method includes the dry blending of chemical blowing agents with the polyester and then extruding or molding the blend to provide foamed articles. During the extrusion or molding operation, an inert gas such as nitrogen is released from the blowing agents and provides the foaming action. Typical blowing agents include azodicaronamide, hydrazocarbonamide, dinitrosopentamethylenetetramine, p-toluenesulfonyl hydrazodicarboxylate, 5-phenyl-3,6-dihydro-1,3,4-oxa-diazin-2-one, sodium borohydride, sodium bicarbonate, 5-phenyltetrazole, and p,p′-oxybis(benzenesulfonylhydrazide). Still another method includes the blending of sodium carbonate or sodium bicarbonate with one portion of polymer pellets, blending of an organic acid, such as citric acid, with another portion of polymer pellets and then blending of the two types of pellets by extruding or molding at elevated temperatures. Carbon dioxide gas is released from the interaction of the sodium carbonate and citric acid to provide the desired foaming action in the polymeric melt.

### Additives

Also to be considered is whether the foam includes other additives. With any polymeric resin-based compound, additives can provide easier processing and a more desirable final appearance and properties for the compound.

The additive can be any compound known to those of skill in the art to be useful in the production of polymeric articles. Exemplary additives include, e.g., plasticizers (e.g., to increase flexibility of the polymeric composition), antioxidants (e.g., to protect the polymeric composition from degradation by ozone or oxygen), ultraviolet stabilizers (e.g., to protect against weathering), lubricants (e.g., to reduce friction), pigments (e.g., to add color to the polymeric composition), flame retardants, fillers, antistatic agents, reinforcing agents, and/or mold release agents. Optimal amounts to be added will depend on various factors known to skilled practitioners, e.g., cost, desired physical characteristics of the polymeric composition (e.g., mechanical strength), and the type of processing to being performed (raising, e.g., considerations of line speeds, cycle times, and other processing parameters). It is well within the skilled practitioner's abilities to determine whether an additive should be included in a polymeric composition and, if so, what additive and the amount that should be added to the composition.

Nucleating agents can be used to control the rate at which the polymer crystallizes. Plasticizers are used to aid processing, change the glass transition temperature and modulus of the composition. Surfactants are generally used to de-dust, lubricate, reduce surface tension, and/or densify. Lubricants are normally used to reduce sticking to hot processing metal surfaces. Binders can beneficially unite the other components within the polymer. Fillers ordinarily are used to reduce cost and gloss. Antioxidants can be used to prevent aging and embrittlement of the polymer. Impact modifiers are useful in rigid polymers to increase toughness. Pigments and colorants can be organic, or can be minerals such as titanium dioxide, and can be opacifying pigments, or tinting pigments.

For instance, the polymeric composition can also include an optional nucleating agent to aid in crystallization of the polymeric composition.

### Nucleating Agents

For instance, an optional nucleating agent is added to the branched PHA to aid in its crystallization. Nucleating agents for various polymers are simple substances, metal compounds including composite oxides, for example, carbon black, calcium carbonate, synthesized silicic acid and salts, silica, zinc white, clay, kaolin, basic magnesium carbonate, mica, talc, quartz powder, diatomite, dolomite powder, titanium oxide, zinc oxide, antimony oxide, barium sulfate, calcium sulfate, alumina, calcium silicate, metal salts of organophosphates, and boron nitride; low-molecular organic compounds having a metal carboxylate group, for example, metal salts of such as octylic acid, toluic acid, heptanoic acid, pelargonic acid, lauric acid, myristic acid, palmitic acid, stearic acid, behenic acid, cerotic acid, montanic acid, melissic acid, benzoic acid, p-tert-butylbenzoic acid, terephthalic acid, terephthalic acid monomethyl ester, isophthalic acid, and isophthalic acid monomethyl ester; high-molecular organic compounds having a metal carboxylate group, for example, metal salts of such as: carboxyl-group-containing polyethylene obtained by oxidation of polyethylene; carboxyl-group-containing polypropylene obtained by oxidation of polypropylene; copolymers of olefins, such as ethylene, propylene and butene-1, with acrylic or methacrylic acid; copolymers of styrene with acrylic or methacrylic acid; copolymers of olefins with maleic anhydride; and copolymers of styrene with maleic anhydride; high-molecular organic compounds, for example: alpha-olefins branched at their 3-position carbon atom and having no fewer than 5 carbon atoms, such as 3,3 dimethylbutene-1,3-methylbutene-1,3-methylpentene-1,3-methylhexene-1, and 3,5,5-trimethylhexene-1; polymers of vinylcycloalkanes such as vinylcyclopentane, vinylcyclohexane, and vinylnorbornane; polyalkylene glycols such as polyethylene glycol and polypropylene glycol; poly(glycolic acid); cellulose; cellulose esters; and cellulose ethers; phosphoric or phosphorous acid and its metal salts, such as diphenyl phosphate, diphenyl phosphite, metal salts of bis(4-tert-butylphenyl)phosphate, and methylene bis-(2,4-tert-butylphenyl)phosphate; sorbitol derivatives such as bis(p-methylbenzylidene)sorbitol and bis(p-ethylbenzylidene)sorbitol; and thioglycolic anhydride, p-toluenesulfonic acid and its metal salts. The above nucleating agents may be used either alone or in combinations with each other. In particular embodiments, the nucleating agent is cyanuric acid. In certain embodiments, the nucleating agent can also be another polymer (e.g., polymeric nucleating agents such as PHB).

In certain embodiments, the nucleating agent is selected from: cyanuric acid, carbon black, mica talc, silica, boron nitride, clay, calcium carbonate, synthesized silicic acid and salts, metal salts of organophosphates, and kaolin. In particular embodiments, the nucleating agent is cyanuric acid.

In various embodiments, where the nucleating agent is dispersed in a liquid carrier, the liquid carrier is a plasticizer, e.g., a citric compound or an adipic compound, e.g., acetylcitrate tributyrate (Citroflex A4, Vertellus, Inc., High Point, N.C.), or DBEEA (dibutoxyethoxyethyl adipate), a surfactant, e.g., Triton X-100, TWEEN-20, TWEEN-65, Span-40 or Span 85, a lubricant, a volatile liquid, e.g., chloroform, heptane, or pentane, a organic liquid or water.

In other embodiments, the nucleating agent is aluminum hydroxy diphosphate or a compound comprising a nitrogen-containing heteroaromatic core. The nitrogen-containing heteroaromatic core is pyridine, pyrimidine, pyrazine, pyridazine, triazine, or imidazole.

In particular embodiments, the nucleating agent can include aluminum hydroxy diphosphate or a compound comprising a nitrogen-containing heteroaromatic core. The nitrogen-containing heteroaromatic core is pyridine, pyrimidine, pyrazine, pyridazine, triazine, or imidazole. The nucleant can have a chemical formula selected from the group consisting of

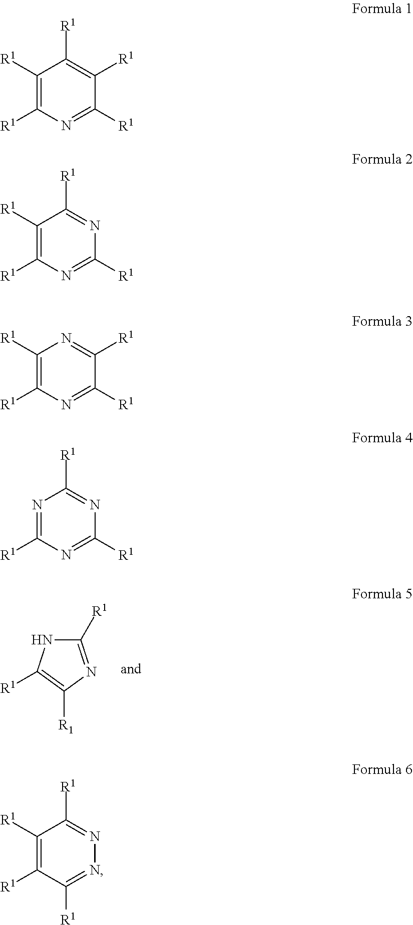

and combinations thereof, wherein each R1 is independently H, NR²R², OR², SR², SOR², SO₂R², CN, COR², CO₂R², CONR²R², NO₂, F, Cl, Br, or I; and each R² is independently H or C₁-C₆ alkyl.

Another nucleating agent for use in the compositions and methods described herein are milled as described in PCT/US2009/041023, filed Apr. 17, 2009, which is incorporated by reference in its entirety. Briefly, the nucleating agent is milled in a liquid carrier until at least 5% of the cumulative solid volume of the nucleating agent exists as particles with a particle size of 5 microns or less. The liquid carrier allows the nucleating agent to be wet milled. In other embodiments, the nucleating agent is milled in liquid carrier until at least 10% of the cumulative solid volume, at least 20% of the cumulative solid volume, at least 30% or at least 40%-50% of the nucleating agent can exist as particles with a particle size of 5 microns or less, 2 microns or less or 1 micron or less. In alternative embodiments, the nucleating agents is milled by other methods, such as jet milling and the like. Additionally, other methods is utilized that reduce the particle size.

The cumulative solid volume of particles is the combined volume of the particles in dry form in the absence of any other substance. The cumulative solid volume of the particles is determined by determining the volume of the particles before dispersing them in a polymer or liquid carrier by, for example, pouring them dry into a graduated cylinder or other suitable device for measuring volume. Alternatively, cumulative solid volume is determined by light scattering.

### Foam Blowing Agent

As used herein, the foam blowing agent, is the agent that is blown into the molten foam composition under suitable conditions to produce the foam. The blowing agent used in any of the methods or foams described herein can be R134a (1,1,1,2-tetrafluoroethane), butane, carbon dioxide, nitrogen, or any other blowing agent used in the foam-making industry. The blowing agent can be added at ratios of addition of about 0.1% to about 10.0%. It can be added at pressures of 1000 to 3000, for example, 1400, 1600, 1800, 2000, 2200, or 2400 psi.

The invention will be further described in the following examples, which do not limit the scope of the invention defined by the claims.

For the fabrication of useful articles, a polymeric composition described herein is created at a temperature above the crystalline melting point of the thermoplastic but below the decomposition point of any of the ingredients of the composition. Alternatively, a pre-made blend composition of the present invention is simply heated to such temperature. Such processing can be performed using any art-known technique used to make foam. The polymeric compositions of the present invention can be used to create, without limitation, a wide variety of useful products, e.g., automotive, consumer durable, construction, electrical, medical, and packaging products. For instance, the polymeric compositions can be used to make, without limitation, foams and shaped or molded foamed articles.

The invention will be further described in the following examples, which do not limit the scope of the invention defined by the claims.

### EXAMPLES

### Testing Methods

### Measurement of Molecular Weight of Polymers

Molecular weight (either weight-average molecular weight (Mw) or number-average molecular weight (Mn)) of PHA is estimated by gel permeation chromatography (GPC) using, e.g., a Waters Alliance HPLC System equipped with a refractive index detector. The column set is, for example, a series of three PLGel 10 micrometer Mixed-B (Polymer Labs, Amherst, Mass.) columns with chloroform as mobile phase pumped at 1 ml/min. The column set is calibrated with narrow distribution polystyrene standards.

The PHA sample is dissolved in chloroform at a concentration of 2.0 mg/ml at 60 C. The sample is filtered with a 0.2 micrometer Teflon syringe filter. A 50 microliter injection volume is used for the analysis.

The chromatogram is analyzed with, for example, Waters Empower GPC Analysis software. Molecular weights and PD are reported as polystyrene equivalent molecular weights.

The GPC method become inaccurate when measuring molecular weights over about one million. For polymers with such high molecular weights, the weight average molecular weight is estimated by flow injection polymer analysis (FIPA) system (commercially available from, e.g., Viscotek Corp, Houston, Tex.) The polymer solution is eluted through a single, low volume size exclusion to separate polymer, solvent and impurities. The detection system consists of a refractive index, light scattering and viscosity group.

The polymer sample is dissolved in chloroform at a concentration of 2.0 mg/ml at 60 C. The sample is filtered with a 0.2 micrometer Teflon syringe filter. The FIPA unit operates at 45° C. with tetrahydrofuran mobile phase at a flow rate of 1.0 ml/min. A 100 microliter injection volume is used for the analysis.

The chromatogram is analyzed with, e.g., Viscotek Omni-Sec software. The absolute Mw is reported in grams/mole. For PHA polymers, the absolute Mw (as measured by FIPA) is related to the Mw (as measured

by GPC in polystyrene equivalents) by dividing the GPC value by approximately 1.3. Measurement of Thermal Stability

The thermal stability of a polymer sample is measured in two different ways. The thermal stability is represented herein by a sample's “k,” which shows the change in Mw over time. It can also be measured by melt capillary stability (MCS), which shows the change in the capillary shear viscosity over time.

To measure the thermal stability (“k”) of a sample, a polymer specimen (e.g., 2 mg) is exposed to 170° C. in a DSC test chamber (e.g., a TA Instrument Q-2000), and the specimen heated for 0, 5 and 10 minutes. The cooled sample cup is unsealed and the sample dissolved in chloroform to the concentration required for gel permeation chromatography (GPC). GPC is used to measure Mw, Mn and Mz molecular weight averages of polymers, relative to a 900K polystyrene control.

The slope of the best-fit straight line of reciprocal weight-average molecular weight (1/Mw) versus time is the thermal stability of the sample in moles per gram per minute. A smaller “k” translates to better thermal stability.

The thermal stability of a sample is measured using a capillary rheometry test. Capillary rheometers are generally used to measure the melt viscosity of plastics as a function of shear rate (typically from about 0.1 to 10,000 sec⁻¹). However, measuring the melt viscosity of PHA polymers is complicated, because the molecular weight degradation reaction occurs at the test conditions themselves, which results in decreasing viscosity as a function of melt dwell time.

This obstacle is overcome by measuring the melt viscosity at various dwell times and extrapolating back to zero time (this is described in ASTM D3835-08). In the tests used herein, measurements are performed at 180° C. The material is preheated for 240 seconds (4 minutes) before the testing is commenced, and a capillary die of 0.75 mm diameter and 30 mm length is used. The measured apparent viscosity (as calculated from pressure and rate) decreases with increasing dwell time in the rheometer. When measured apparent viscosity (at an apparent shear rate of 100 sec⁻¹) is plotted as a function of time, the slope of this best-fit straight line is used as another indicator of thermal stability. This slope is referred to as “melt capillary stability,” or MCS. The MCS number is negative, because viscosity decreases with time, and a larger magnitude (i.e., a smaller number) corresponds to poorer thermal stability. In other words, a negative number closer to zero is more desirable, and a larger negative number is less desirable.

### Measuring G′ Using Torsional Melt Rheometry

Torsional rheometry is used to measure the melt strength of a polymer. For purposes of simplicity, G′ will be used herein, measured at an imposed frequency of 0.25 rad/s as a measure of “melt strength” (unless otherwise indicated). Higher G′ translates to higher melt strength.

All oscillatory rheology measurements are performed using a TA Instruments AR2000 rheometer employing a strain amplitude of 1%. First, dry pellets (or powder) are molded into 25 mm diameter discs that are about 1200 microns in thickness. The disc specimens are molded in a compression molder set at about 165° C., with the molding time of about 30 seconds. These molded discs are then placed in between the 25 mm parallel plates of the AR2000 rheometer, equilibrated at 180° C., and subsequently cooled to 160° C. for the frequency sweep test. A gap of 800-900 microns is used, depending on the normal forces exerted by the polymer. The melt density of PHB is determined to be about 1.10 g/cm³ at 160° C.; this value is used in all the calculations.

Specifically, the specimen disc is placed between the platens of the parallel plate rheometer set at 180° C. After the final gap is attained, excess material from the sides of the platens is scraped. The specimen is then cooled to 160° C. where the frequency scan (from 625 rad/s to 0.10 rad/s) is then performed; frequencies lower than 0.1 rad/s are avoided because of considerable degradation over the long time it takes for these lower frequency measurements. The specimen loading, gap adjustment and excess trimming, all carried out with the platens set at 180° C., takes about 2½ minutes. This is controlled to within ±10 seconds to minimize variability and sample degradation. Cooling from 180° C. to 160° C. (test temperature) is accomplished in about four minutes. Exposure to 180° C. ensures a completely molten polymer, while testing at 160° C. ensures minimal degradation during measurement.

During the frequency sweep performed at 160° C., the following data are collected as a function of measurement frequency: |η*| or complex viscosity, G′ or elastic modulus (elastic or solid-like contribution to the viscosity) and G″ or loss modulus (viscous or liquid-like contribution to the viscosity).

As used herein, G′ measured at an imposed frequency of 0.25 rad/s (unless otherwise indicated) is used as a measure of “melt strength.” Higher G′ translates to higher melt strength.

### Measurements of Foam Density

Measurement of foam density were performed following ASTM D792 procedure. This involves measuring the weight of a foam sample both in air and under water, and calculating the density according to the equation:

Df=Dw*[WFa/(WFa−WFw)]

Df=Density of foam
Dw=Density of water=1 gr/cc
WFa=Weight of foam in air
WFw=Weight of foam under water

### Measurements of Foam Cell Size

Measurement of foam cell size were estimated visually via light microscope.

### Example 1

### Use of Polyhydroxyalkanoate Blend to Make Foam

In this example, a blend of polyhydroxyalkanoate polymers was used to make foam. The foam formulation consisted of two parts, a base resin and a foam cell nucleation resin. The two resins were then combined on a tandem extruder foam line to make foam.

The base resin contained 94.0% by weight poly(3-hydroxybutyrate), 3.0% by weight nucleating masterbatch (boron nitride that had been previously compounded at a rate of 33% (by weight) into a base resin of 3-hydroxybutanoic acid and 4-hydroxybutanoic acid, and pelleted), and 3.0% by weight branching agent (dicumyl peroxide dissolved at a rate of 10% (by weight) in warmed Citroflex A4 plasticizer).

The cell nucleation resin contained blended polyhydroxyalkanoates composed of about 38% to about 42% by weight polyhydroxybutyrate, and about 58% to about 62% PHB Type 1 copolymer. It contained 58% by weight of this polyhydroxyalkanoate blend, 2% by weight nucleating masterbatch (the same as that used for the base resin), 20% talc, and 10% Joncryl ADR-4368CS.

The foam formulation was made up of 96.7% by weight base resin and 3.3% by weight cell nucleation resin. Foam was made on a tandem extruder foam line under the following conditions: gas R134a applied at a pressure of 1470 (psi) and a flow rate of 4 ml/min, extruder 1 operated at 40.6 rpm, amperage of 9, zones at 179/175/168° C., upper, middle and lower dies at 164, 166, 165° C., a transfer melt temperature of 165° C., and extruder pressure of 1810 psi and transfer pressure of 1110 psi; extruder 2 was operated at 3 rpm, 21% load, zones 1-5 at 165° C., adaptor blocks at 165 and 166° C., die at 170° C. and 740 psi, head at 390 psi, and extrusion through the die at a rate of 120 grams per minute.

The foam had a density of about 0.10 grams per cubic centimeter, and an average cell size of about 0.84 millimeters.

### Example 2

### All-In-One Foam Formulations

In this example, foam formulations were made that combined the foam cell nucleation function into the base resin, thereby obviating the need for a two-part foam formulation.

The first all-in-one resin contained 94.0% by weight poly(3-hydroxybutyrate), 3.0% by weight nucleating masterbatch (boron nitride that had been previously compounded at a rate of 33% (by weight) into a base resin of 3-hydroxybutanoic acid and 4-hydroxybutanoic acid, and pelleted), and 3.0% by weight branching agent (dicumyl peroxide dissolved at a rate of 10% (by weight) in warmed Citroflex A4 plasticizer).

This first all-in-one resin was converted to foam on a tandem extruder foam line under the following conditions: gas R134a applied at a pressure of 1270 (psi) and a flow rate of 4, extruder 1 operated at 39.9 rpm, amperage of 8, zones at 180/175/165° C., upper, middle and lower dies at 165, 163, 164° C., a transfer melt temperature of 168° C., and extruder pressure of 1380 psi and transfer pressure of 610 psi; extruder 2 was operated at 3 rpm, 17% load, zones 1-5 at 165° C., adaptor blocks at 165° C., die at 170° C. and 390 psi, head at 200 psi, and extrusion through the die at a rate of 113 grams per minute.

The foam had a density of about 0.14 grams per cubic centimeter, and an average cell size of about 2.5 millimeters.

The second all-in-one resin contained 93.1% poly(3-hydroxybutyrate), 3.0% by weight nucleating masterbatch (boron nitride that had been previously compounded at a rate of 33% (by weight) into a base resin of 3-hydroxybutanoic acid and 4-hydroxybutanoic acid, and pelleted), and 3.0% by weight branching agent (dicumyl peroxide dissolved at a rate of 10% (by weight) in warmed Citroflex A4 plasticizer). It also contained 0.4% (by weight) Joncryl ADR-4368CS, and 1.0% (by weight) talc blended with 1.0% (by weight) PHA blend. The talc was combined with the PHA blend (about 58-62% homo-polymer of 3-hydroxybutanoic acid, and about 38-42% PHB Type I copolymer) to ensure uniform distribution.

The second all-in-one resin was converted to foam on a tandem extruder foam line under the following conditions: gas R134a applied at a pressure of 2250 (psi) and a flow rate of 5, extruder 1 operated at 40.8 rpm, amperage of 10, zones at 181/175/173° C., upper, middle and lower dies at 166, 163, 164° C., a transfer melt temperature of 163° C., and extruder pressure of 2550 psi and transfer pressure of 1430 psi; extruder 2 was operated at 3 rpm, 19% load, zones 1-5 at 165° C., adaptor blocks at 165-164° C., die at 170° C. and 1180 psi, head at 980 psi, and extrusion through the die at a rate of 120 grams per minute.

The foam was dense (0.69 gr/cc), and an average cell size of about 0.28 millimeters.

### Example 3

### Use of Polyhydroxybutyrate to Make Foam

Polyhydroxybutyrate was used on a tandem foam extrusion line in an attempt to make polyhydroxybutyrate foam. The base resin was formulated as follows:

TABLE 1
PHB Base Resin Formulation.

| Ingredient | Amount (lbs) |
|---|---|
| Poly(3-hydroxybutyrate) | 141.0 |
| Nucleating agent | 4.5 |
| Acrawax-C concentrate (50% active) | 3.0 |
| Citroflex A4 | 1.2 |
| Dicumyl peroxide (DiCuP) | 0.3 |

The nucleating agent in Table 1 is cyanuric acid that had been previously compounded at a rate of 33% (by weight) into a resin mixture of 3-hydroxybutanoic acid and 4-hydroxybutanoic acid, and pelleted. These pellets were added at the rate listed in Table 1.

Dicumyl peroxide was added as a branching agent. It is normally a solid. It was prepared by heating the plasticizer Citroflex A4 to 60° C., and then melting the dicumyl peroxide in the warmed Citroflex A4.

The ingredients in Table 1 were compounded into base resin pellets on a Leistritz 27 mm MAXX twin-screw extruder. The polymer, nucleating agent and the Acrawax-C were added at the feed throat. The Citroflex A4 and the dicumyl peroxide were added by a liquid pump at barrel zone 1. Vacuum was applied at barrel zone 8.

The mixture was processed into pellets at 60 lbs/hour, with a screw speed of 100 rpm, with the temperatures on the extruder zones set at: 150/175/175/175/170/170/170/170/170/170/170 (die) ° C.

This formulation was then fed into a tandem extruder foam line using R134a as the blowing agent.

In the production of foam, it is common in the art to place two extruders in series. The first extruder melts the polymer and dissolves the foaming agent into the polymer mix. The second extruder cools the mixture, making it more viscous and partially setting up the material, and then extruding the foam. The polymer formulations were made into foam under the conditions described in Table 2, below.

TABLE 2
Foam Runs With PHB as the Base Resin

| | Run | | | | |
|---|---|---|---|---|---|
| | PHB-a | PHB-b | PHB-c | PHB-d | PHB-e |
| Polymer Rate | 106 | 96 | 107 | | 250 |
| (gr/min) | | | | | |
| Blowing Agent | R-134a | R-134a | R-134a | R-134a | R-134a |
| Flow Rate | 2 | 4 | 6 | 10 | 8 |
| (mL/min) | | | | | |
| Extruder 1 | | | | | |
| (° C.) | | | | | |
| RPM | 39.9 | 39.9 | 39.8 | 40 | 80 |
| Zone 1 | 180 | 180 | 180 | 180 | 185 |
| Zone 2 | 175 | 175 | 175 | 175 | 180 |
| Zone 3 | 165 | 170 | 170 | 170 | 170 |
| Upper Die | 160 | 165 | 165 | 165 | 176 |
| Middle Die | 160 | 165 | 165 | 165 | 165 |
| Lower Die | 161 | 165 | 165 | 165 | 161 |
| Gas Injection | 960 | 1040 | 1040 | 890 | 1950 |
| Pressure (psi) | | | | | |
| Extruder 2 | 1510 | 1050 | 950 | 980 | 1180 |
| Entrance | | | | | |
| Pressure (psi) | | | | | |
| Extruder 2 | | | | | |
| (° F.) | | | | | |
| RPM | 3 | 3 | 3 | 3 | 14 |
| Zone 1 | 320 | 329 | 329 | 329 | 320 |
| Zone 2 | 320 | 329 | 329 | 329 | 302 |
| Zone 3 | 320 | 329 | 329 | 329 | 302 |
| Zone 4 | 320 | 329 | 329 | 329 | 284 |
| Zone 5 | 320 | 329 | 329 | 329 | 284 |
| Adaptor | 321 | 330 | 330 | 330 | 284 |
| Block 1 | | | | | |
| Adaptor | 320 | 329 | 329 | 329 | 284 |
| Block 2 | | | | | |
| Die Temp | 320 | 329 | 329 | 329 | 284 |
| Die Pressure | 1400 | 950 | 800 | 800 | 2400 |
| Foam Density | 0.225 | 0.487 | 0.592 | 0.595 | 0.751 |
| (gr/cc) | | | | | |
| Melt | 160 | 165 | 160 | | |
| Temperature | | | | | |
| (C.) | | | | | |
| Sample | 1 | 2 | 3 | 4 | 5 |
| Number | | | | | |
| Comments | Cork | rough | rough | rough | smooth |
| | Screw | | | | |

The results show that manipulation of the extruder temperatures and conditions fail to produce a set of conditions under which good foam could be made reliably. The first run did produce a dense foam of 0.25 grams/cc, but this is not considered to be of good quality.

Surprisingly, increasing the pressure or flow rate of the blowing agent gas did not produce a less dense foam. Instead, the cellular structure of the foam collapsed.

### Example 4

### Use of Polyhydroxyalkanoate Blend to Make Foam

In this example, a blend of polyhydroxyalkanoate polymers was used, both without and with additional additives to improve melt strength.

### A. Production of Base Resin

A blend of 3-hydroxybutanoic acid and 4-hydroxybutanoic acid was compounded as follows to make pellets of base resin.

TABLE 3
Base Resin Formulation

| Ingredient | Amount (lbs) |
|---|---|
| Polymer blend | 140.3 |
| Nucleating agent | 4.50 |
| Acrawax-C concentrate (50% active) | 3.00 |
| Citroflex A4 | 1.80 |
| Dicumyl peroxide (0.3%) (DiCuP) | 0.45 |

The PHA blend was composed of about 58-62% homo-polymer of 3-hydroxybutanoic acid, and about 38-42% co-polymer of 3-hydroxybutanoic acid and 4-hydroxybutanoic acid, where the 4-hydroxybutanoic acid is approximately 10-12%. The nucleating agent in Table 3 is cyanuric acid that had been previously compounded at a rate of 33% (by weight) into a base resin of 3-hydroxybutanoic acid and 4-hydroxybutanoic acid, and pelleted. These pellets were added at the rate listed in Table 3.

Dicumyl peroxide was added as a branching agent. It is normally a solid. It was prepared by heating the plasticizer Citroflex A4 to 60° C., and then melting the dicumyl peroxide in the warmed Citroflex A4.

The ingredients in Table 3 were compounded into base resin pellets on a Leistritz 27 mm MAXX twin-screw extruder. The polymer, nucleating agent, and the Acrawax-C were added at the feed throat. The Citroflex A4 and the dicumyl peroxide were added by a liquid pump at barrel zone 1.

The mixture was processed into pellets at 60 lbs/hour, with a screw speed of 100 rpm, with the temperatures on the extruder zones set at: 150/175/175/175/170/170/170/170/170/170/170 (die) ° C. Vacuum was applied at barrel zone 8.

### B. Formulation of Cell Nucleation Concentrate

A blend of 3-hydroxybutanoic acid and 4-hydroxybutanoic acid was also used to make pellets of the cell nucleation concentrate. The PHA blend was the same as that used in Table 3, above.

TABLE 4
Cell Nucleation Concentrate Formulation

| Ingredient | Amount (lbs) |
|---|---|
| Polymer blend | 27.00 |
| Nucleating agent | 1.50 |
| Acrawax-C concentrate (50% active) | 1.00 |
| Citroflex A4 | 0.50 |
| Talc | 15.00 |
| Joncryl ADR-4368 | 5.00 |

The nucleating agent was the same as in Table 3, above. The talc was Flextalc 610D from Specialty Minerals. Joncryl ADR-4368 is an epoxy-functional polymeric acrylic.

The above ingredients were compounded into pellets on a Leistritz 27 mm MAXX twin-screw extruder. The polymer, nucleating agent, and the Acrawax-C concentrate were added to the feed throat. The talc and the Joncryl ADR-4368 were added at Barrel 4. The Citroflex A4 was added at Barrel 1 by liquid pump.

The mixture was processed into pellets at 60 lbs/hour, with a screw speed of 100 rpm, with the temperatures on the extruder zones set at: 150/175/175/175/170/170/170/170/170/180/180 (die) ° C.

### C. Production of Polyhydroxyalkanoate Foam

The base resin pellets were used alone to make foam (first two runs in Table below), or were dry blended together with the cell nucleation concentrate pellets at a ratio of 96.7% base resin pellets and 3.3% cell nucleation concentrate pellets (by weight) (next three runs in Table below).

These formulations were then fed into a tandem extruder foam line using either R134a blowing agent or butane as the blowing agent. The polymer throughput rate was approximately 100 grams/hour for all the runs.

In the production of foam, it is common in the art to place two extruders in series. The first extruder melts the polymer and dissolves the foaming agent into the polymer mix. The second extruder cools the mixture, making it more viscous and partially setting up the material, and then extruding the foam. The polymer formulations were made into foam under the conditions described in Table 5, below.

TABLE 5
Production of Foam From a Polyhydroxybutyrate Blend

| | Run | | | | |
|---|---|---|---|---|---|
| | PHB | PHB | PHB | PHB | PHB |
| | Blend-a | Blend-b | Blend-c | Blend-d | Blend-e |
| Additive | none | none | cell nuc. | cell nuc. | cell nuc. |
| | | | conc. | conc. | conc. |
| Loading | | | 3.30% | 3.30% | 3.30% |
| Description | | | Talc + | Talc + | Talc + |
| | | | Joncryl | Joncryl | Joncryl |
| Blowing Agent | R-134a | R-134a | R-134a | R-134a | R-134a |
| Flow Rate | 2 | 2 | 2 | 3 | 4 |
| (mL/min) | | | | | |
| Extruder 1 (° C.) | | | | | |
| RPM | 40.1 | 40.1 | 40.3 | 40.3 | 40.3 |
| Zone 1 | 180 | 180 | 180 | 180 | 180 |
| Zone 2 | 175 | 175 | 175 | 175 | 175 |
| Zone 3 | 165 | 165 | 170 | 170 | 171 |
| Upper Die | 170 | 170 | 169 | 169 | 167 |
| Middle Die | 165 | 165 | 166 | 166 | 165 |
| Lower Die | 165 | 165 | 165 | 165 | 165 |
| Gas Injection | 1280 | 1360 | 2060 | 2000 | 2020 |
| Pressure (psi) | | | | | |
| Extruder 2 | 1630 | 1570 | 2240 | 2160 | 2090 |
| Entrance | | | | | |
| Pressure (psi) | | | | | |
| Extruder 2 (° F.) | | | | | |
| RPM | 3 | 3 | 3 | 3 | 3 |
| Zone 1 | 329 | 329 | 329 | 329 | 329 |
| Zone 2 | 320 | 329 | 329 | 329 | 329 |
| Zone 3 | 320 | 329 | 329 | 329 | 329 |
| Zone 4 | 320 | 329 | 329 | 329 | 329 |
| Zone 5 | 320 | 329 | 329 | 329 | 329 |
| Adaptor Block 1 | 319 | 329 | 329 | 329 | 329 |
| Adaptor Block 2 | 320 | 329 | 329 | 329 | 329 |
| Die Temp | 320 | 329 | 329 | 329 | 329 |
| Die Pressure (psi) | 1600 | 1400 | 2000 | 1900 | 1800 |
| Foam Density | 0.279 | 0.194 | 0.171 | 0.156 | 1.01 |
| (gr/cc) | | | | | |
| Melt | Spiral | spiral | | | |
| Comments | | | | | |

The first two runs were made from base resin pellets only. Both produced a dense, heavy foam.

The remaining three runs were from a dry blend of base resin and cell nucleation concentrate in the form of pellets. Among the three runs, the pressure and flow rates were adjusted to try to find optimal foam producing conditions. The best run was the second of the three run. It was found that better foam was produced with the addition of talc and epoxy-functional polymeric acrylic.

### Example 5

### Effect of Additional Talc and Epoxy-Functional Polymeric Acrylic

The runs of Example 4, above, were repeated, but the weight percentage of the cell nucleation concentrate pellets was doubled, to a ratio of 93.4% base resin pellets and 6.6% cell nucleation concentrate pellets (by weight).

The conditions and results are shown in Table 6, below. For comparison purposes, run 5 from Table 5 (above) is included.

In the fourth run in Table 6, below, clay was substituted for the talc. The clay was an organically modified montmorillonite clay (SCPX3016, from Southern Clay Products, Inc.).

TABLE 6
Production of Foam from a Polyhydroxybutyrate Blend

| | Run | | | |
|---|---|---|---|---|
| | PHB | PHB | PHB | PHB |
| | Blend-f | Blend-g | Blend-h | Blend-i |
| Additive | 1x cell | 2x cell | 2x cell | 1x cell |
| | nuc. | nuc. | nuc. | nuc. |
| | conc. | conc. | conc. | conc. |
| Loading | 3.30% | 6.60% | 6.60% | 3.30% |
| Description | 610D Talc + | 610D Talc + | 610D Talc + | Clay + |
| | Joncryl | Joncryl | Joncryl | Joncryl |
| Additive | Talc + | Talc + | Talc + | Talc + |
| | Awax | Awax | Awax | Awax |
| Blowing Agent | R-134a | R-134a | R-134a | R-134a |
| Flow Rate | 4 | 4 | 3 | 3 |
| (mL/min) | | | | |
| Extruder 1 (° C.) | | | | |
| RPM | 40.3 | 40.3 | 40.2 | 40.2 |
| Zone 1 | 180 | 180 | 180 | 180 |
| Zone 2 | 175 | 176 | 175 | 175 |
| Zone 3 | 169 | 169 | 169 | 165 |
| Upper Die | 167 | 166 | 167 | 165 |
| Middle Die | 165 | 165 | 165 | 165 |
| Lower Die | 165 | 165 | 165 | 165 |
| Extruder Pressure | 1870 | 2020 | 2250 | 1880 |
| Die Pressure | 1970 | 2190 | 2320 | 1750 |
| Extruder 2 (° F.) | | | | |
| RPM | 3 | 3 | 3 | 3 |
| Zone 1 | 329 | 329 | 329 | 329 |
| Zone 2 | 329 | 329 | 329 | 329 |
| Zone 3 | 329 | 329 | 329 | 329 |
| Zone 4 | 329 | 329 | 329 | 329 |
| Zone 5 | 329 | 329 | 329 | 329 |
| Adaptor Block 1 | 330 | 329 | 329 | 329 |
| Adaptor Block 2 | 329 | 329 | 329 | 329 |
| Die Temp | 329 | 329 | 330 | 330 |
| Die Pressure | 1800 | 2000 | 2200 | 1600 |
| Foam Density | 1.01 | 0.731 | 0.363 | 0.140 |
| (gr/cc) | | | | |

The above results show that doubling the cell nucleation concentrate produces little gain in the finished foam. It also shows that talc does not necessarily impart unique properties, and that clay can be substituted for the talc. It also shows that lower gas levels produce better expansion.

### Example 6

### Production of Foam With Butane Blowing Agent

Run PHB Blend-d from Example 4, above, was repeated using butane as the blowing agent. The formulations were prepared as for Example 2. The run conditions were as follows.

TABLE 7
Production of Foam from a Polyhydroxybutyrate Blend
With Butane Blowing Agent

| | Run | | | |
|---|---|---|---|---|
| | PHB | PHB | PHB | PHB |
| | Blend-j | Blend-k | Blend-l | Blend-m |
| Loading | 3.30% | 3.30% | 3.30% | 3.30% |
| Additive | 610D | 610D | 610D | 610D |
| | Talc + | Talc + | Talc + | Talc + |
| | Joncryl | Joncryl | Joncryl | Joncryl |
| Blowing Agent | Butane | Butane | Butane | Butane |
| Flow Rate (mL/min) | 2 | 3 | 4 | 5 |
| Extruder 1 (° C.) | | | | |
| RPM | 40.6 | 40.6 | 40.6 | 40.6 |
| Zone 1 | 180 | 180 | 180 | 180 |
| Zone 2 | 175 | 176 | 178 | 178 |
| Zone 3 | 169 | 171 | 171 | 170 |
| Upper Die | 167 | 166 | 165 | 165 |
| Middle Die | 164 | 165 | 165 | 165 |
| Lower Die | 165 | 165 | 165 | 165 |
| Gas Injection | 2150 | 2440 | 2350 | 2190 |
| Pressure (psi) | | | | |
| Extruder 2 Entrance | 2220 | 2300 | 2100 | 2050 |
| Pressure (psi) | | | | |
| Extruder 2 (° F.) | | | | |
| RPM | 3.1 | 3.1 | 3 | 3.1 |
| Zone 1 | 329 | 329 | 329 | 329 |
| Zone 2 | 329 | 329 | 329 | 329 |
| Zone 3 | 329 | 329 | 329 | 329 |
| Zone 4 | 329 | 329 | 329 | 329 |
| Zone 5 | 329 | 329 | 329 | 329 |
| Adaptor Block 1 | 330 | 330 | 329 | 330 |
| Adaptor Block 2 | 329 | 329 | 329 | 329 |
| Die Temp | 329 | 329 | 329 | 329 |
| Die Pressure | 2000 | 2200 | 2000 | 2000 |
| Foam Density (gr/cc) | 0.236 | 0.137 | 0.117 | 0.318 |

Interestingly, butane appeared to require greater flow rates than R134a to produce the same density of foam. However, these results show that it is possible to produce foam with attractive densities (e.g., 0.12 grams/cc) and good expansion rates (e.g., ˜10×).

### Example 7

### Production of Polyhydroxyalkanoate Foam

Various formulations were made for making foam from polyhydroxyalkanoate blends.

Foam production generally involves the mixture of two types of polymer resins: a base resin, which makes up most of the foam, and a cell nucleation resin, which when combined with the base resin causes formation of the cells in the finished foam. Alternatively, both of these can be combined into a single resin formulation. Both approaches were explored in this example.

TABLE 8
Base Resin Formulations

| Base Resin | Base A | Base B | Base C | Base D |
|---|---|---|---|---|
| PHB (wt %) | 94.0 | 94.0 | 92.0 | 93.1 |
| Citroflex A4 (wt %) | 2.7 | 2.7 | 2.7 | 1.35 |
| DiCuP (wt %) | 0.3 | 0.3 | 0.3 | 0.15 |
| Nucleating Masterbatch (wt %) | 3.0 | 3.0 | 3.0 | 3.00 |
| Talc (wt %) | — | — | 1.0 | 1.00 |
| PHA Blend 1 (wt %) | — | — | 1.0 | 1.00 |
| Joncryl (wt %) | — | — | — | 0.40 |

TABLE 9
Cell Nucleation Resin Formulations

| Cell Nucleation Resin | CN A | CN B | CN C | CN D | CN E | CN F |
|---|---|---|---|---|---|---|
| PHB (wt %) | 58.0 | — | — | — | — | — |
| PHA Blend 1 (wt %) | — | 46.4 | 54.4 | 70.4 | 46.4 | 54.4 |
| PHA Blend 2 (wt %) | — | 11.6 | 13.6 | 17.6 | 11.6 | 13.6 |
| Nucleating Masterbatch | 2.0 | 2.0 | 2.0 | 2.0 | 2.0 | 2.0 |
| (wt %) | | | | | | |
| Talc (wt %) | 30.0 | 30.0 | 30.0 | — | — | — |
| CaCO₃ (wt %) | — | — | — | — | 30.0 | 30.0 |
| Joncryl (wt %) | 10.0 | 10.0 | — | 10.0 | 10.0 | — |

“PHB” is poly(3-hydroxybutyrate). “PHA Blend 1” was composed of about 58-62% homo-polymer of 3-hydroxybutanoic acid, and about 38-42% co-polymer of 3-hydroxybutanoic acid and 4-hydroxybutanoic acid, where the 4-hydroxybutanoic acid is approximately 8-14% weight percent. “PHA Blend 2” was composed of about 18-22% homo-polymer of 3-hydroxybutanoic acid, and about 78-82% co-polymer of 3-hydroxybutanoic acid and 4-hydroxybutanoic acid, where the 4-hydroxybutanoic acid is approximately 8-14% weight percent. “DiCuP” is the branching agent dicumyl peroxide, which was dissolved at a rate of 10% (by weight) in warmed Citroflex A4 plasticizer. The amounts in the table represent the final amounts of these components in the formulations. “Nucleating Masterbatch” is the nucleating masterbatch, which was boron nitride that had been previously compounded at a rate of 33% (by weight) into a base resin of 3-hydroxybutanoic acid and 4-hydroxybutanoic acid, and pelleted. “Joncryl” is Joncryl ADR-4368CS.

Base resins B-F were each compounded on a Leistritz MAXX 27 mm twin screw extruder at the temperatures (feed zone to die) 150/175/175/160/150/150/150/150/150/170/170° C. at 100 rpm and a feed rate of 60 lbs/hour.

The cell nucleation resins were compounded on a Leistritz MAXX 27 mm twin screw extruder at the temperatures (feed zone to die) 175/175/175/175/170/170/170/170/170/170/10° C. at 100 rpm and a feed rate of 60 lbs/hour.

Various combinations of The base resins and cell nucleation resins were then combined in various ways to make foam on a tandem extruder foam line. All the formulations below used R134a as the blowing agent.

TABLE 10a
Foam Formulations 1 Through 7

| Formulation | 1 | 2 | 3 | 4 | 5 | 6 | 7 |
|---|---|---|---|---|---|---|---|
| Base Resin Formulation | A | A | A | A | A | A | A |
| Base Resin Amount (wt %) | 96.7 | 96.7 | 96.7 | 93.4 | 96.7 | 100.0 | 96.7 |
| CN Resin Formulation | B | A | D | C&D | E | — | F |
| CN Resin Amount (wt %) | 3.3 | 3.3 | 3.3 | 3.3 | 3.3 | 0.0 | 3.3 |

RUN CONDITIONS:

| | | | | | | | |
|---|---|---|---|---|---|---|---|
| Pressure (psi) | 1320 | 1110 | 1230 | 1390 | 1420 | 1270 | 1000 |
| Flow Rate (ml/min) | 4 | 4 | 4 | 4 | 4 | 4 | 4 |

EXTRUDER 1:

| | | | | | | | |
|---|---|---|---|---|---|---|---|
| RPM | 40 | 40 | 40 | 40.2 | 40.2 | 39.9 | 40.1 |
| Amperage | 9 | 9 | 10 | 9 | 9 | 8.5 | 8 |
| Zone 1 (° C.) | 180 | 180 | 180 | 179 | 180 | 180 | 180 |
| Zone 2 (° C.) | 175 | 175 | 175 | 175 | 175 | 175 | 175 |
| Zone 3 (° C.) | 166 | 166 | 165 | 165 | 165 | 165 | 165 |
| Upper Die (° C.) | 164 | 164 | 166 | 165 | 165 | 165 | 165 |
| Middle Die (° C.) | 163 | 167 | 164 | 164 | 168 | 164 | 163 |
| Lower Die (° C.) | 166 | 167 | 164 | 164 | 166 | 164 | 164 |
| Transfer Melt Temp (° C.) | 166 | 165 | 166 | 166 | 167 | | 168 |
| Extruder Pressure (psi) | 1580 | 1580 | 1670 | 1620 | 1630 | 1390 | 1380 |
| Transfer Pressure (psi) | 740 | 720 | 810 | 810 | 790 | 580 | 610 |

EXTRUDER 2:

| | | | | | | | |
|---|---|---|---|---|---|---|---|
| RPM | 3 | 3 | 3 | 3 | 3 | 3 | 3 |
| % Load | 19 | 19 | 19 | 19 | 19 | 17 | 17 |
| Zone 1 (° C.) | 165 | 165 | 165 | 165 | 165 | 165 | 165 |
| Zone 2 (° C.) | 165 | 165 | 165 | 165 | 165 | 165 | 165 |
| Zone 3 (° C.) | 165 | 165 | 165 | 165 | 165 | 165 | 165 |
| Zone 4 (° C.) | 165 | 165 | 165 | 165 | 165 | 165 | 165 |
| Zone 5 (° C.) | 165 | 165 | 165 | 165 | 165 | 165 | 165 |
| Adaptor Block 1 (° C.) | 165 | 164 | 165 | 165 | 165 | 165 | 165 |
| Adaptor Block 2 (° C.) | 166 | 165 | 165 | 165 | 165 | 165 | 165 |
| Die Temp (° C.) | 170 | 170 | 170 | 170 | 170 | 170 | 170 |
| Die Pressure (psi) | 460 | 500 | 470 | 510 | 500 | 370 | 390 |
| Head Pressure (psi) | 230 | 240 | 240 | 250 | 240 | 200 | 200 |
| Rate (gr/min) | 108 | 106 | 109 | 112 | 110 | 112 | 113 |
| Foam Density (gr/cc) | 0.099 | 0.099 | 0.103 | 0.110 | 0.110 | 0.137 | 0.416 |
| Melt (° C.) | 154 | 157 | 155 | 154 | 156 | 156 | 156 |
| Average Cell Size (mm) | 1.26 | 1.96 | 3.22 | 0.98 | 2.24 | 2.52 | 1.26 |

TABLE 10b
Foam Formulations 8 Through 14

| Formulation | 8 | 9 | 10 | 11 | 12 | 13 | 14 |
|---|---|---|---|---|---|---|---|
| Base Resin | A | A | A | A | A | B | C |
| Base Resin Amount (wt %) | 96.7 | 96.7 | 96.7 | 93.4 | 96.7 | 96.7 | 96.7 |
| CN Resin | C | C | C | C&D | B | B | D |
| CN Resin Amount (wt %) | 3.3 | 3.3 | 3.3 | 3.3 | 3.3 | 3.3 | 3.3 |

RUN CONDITIONS:

| | | | | | | | |
|---|---|---|---|---|---|---|---|
| Pressure (psi) | 1220 | 1070 | 1595 | 1750 | 1950 | 2410 | 1920 |
| Flow Rate (ml/min) | 4 | 4 | 5 | 5 | 5 | 5 | 5 |

EXTRUDER 1:

| | | | | | | | |
|---|---|---|---|---|---|---|---|
| RPM | 40 | 40.3 | 40.3 | 40.5 | 40.8 | 40.8 | 40.9 |
| Amperage | 8 | 8 | 8 | 9 | 10 | 10 | 11 |
| Zone 1 (° C.) | 180 | 180 | 180 | 181 | 180 | 180 | 180 |
| Zone 2 (° C.) | 175 | 175 | 175 | 175 | 175 | 176 | 175 |
| Zone 3 (° C.) | 165 | 165 | 165 | 167 | 168 | 176 | 178 |
| Upper Die (° C.) | 165 | 165 | 164 | 165 | 165 | 166 | 164 |
| Middle Die (° C.) | 167 | 163 | 164 | 167 | 163 | 167 | 166 |
| Lower Die (° C.) | 164 | 166 | 164 | 166 | 166 | 166 | 165 |
| Transfer Melt Temp (° C.) | 168 | 167 | 166 | 167 | 166 | 165 | 164 |
| Extruder Pressure (psi) | 1370 | 1480 | 1670 | 2140 | 2290 | 2500 | 2480 |
| Transfer Pressure (psi) | 580 | 650 | 1000 | 1710 | 1550 | 1550 | 1540 |

EXTRUDER 2:

| | | | | | | | |
|---|---|---|---|---|---|---|---|
| RPM | 3 | 3 | 3 | 3 | 3 | 3 | 3 |
| % Load | 17 | 18 | 19 | 21 | 20 | 20 | 20 |
| Zone 1 (° C.) | 165 | 165 | 165 | 165 | 165 | 165 | 165 |
| Zone 2 (° C.) | 165 | 165 | 165 | 165 | 165 | 165 | 165 |
| Zone 3 (° C.) | 165 | 165 | 165 | 165 | 165 | 165 | 165 |
| Zone 4 (° C.) | 165 | 165 | 165 | 165 | 165 | 165 | 165 |
| Zone 5 (° C.) | 165 | 165 | 165 | 165 | 165 | 165 | 165 |
| Adaptor Block 1 (° C.) | 165 | 165 | 165 | 165 | 165 | 165 | 165 |
| Adaptor Block 2 (° C.) | 165 | 165 | 165 | 165 | 165 | 165 | 166 |
| Die Temp (° C.) | 170 | 170 | 170 | 170 | 170 | 170 | 170 |
| Die Pressure (psi) | 380 | 510 | 940 | 1620 | 1340 | 1270 | 1340 |
| Head Pressure (psi) | 200 | 330 | 760 | 1400 | 1090 | 1060 | 1100 |
| Rate (gr/min) | 110 | 106 | 101 | 101 | 112 | 117 | 115 |
| Foam Density (gr/cc) | 0.539 | 0.65 | 0.779 | 0.2937 | 0.152 | 0.3622 | 0.54 |
| Melt (° C.) | 157 | | 141 | 144 | 156 | 160 | 158 |
| Average Cell Size (mm) | 0.70 | 0.56 | 0.28 | 0.56 | 0.70 | 0.70 | 0.56 |

TABLE 10c
Foam Formulations 15 Through 20

| Formulation | 15 | 16 | 17 | 18 | 19 | 20 |
|---|---|---|---|---|---|---|
| Base Resin | D | A | A | D | C | B |
| Base Resin Amount (wt %) | 100.0 | 96.7 | 96.7 | 96.7 | 96.7 | 96.7 |
| CN Resin | — | B | B | — | D | B |
| CN Resin Amount (wt %) | 0.0 | 3.3 | 3.3 | 0.0 | 3.3 | 3.3 |

RUN CONDITIONS:

| | | | | | | |
|---|---|---|---|---|---|---|
| Pressure (psi) | 2250 | 1960 | 1470 | 1680 | 1720 | 1850 |
| Flow Rate (ml/min) | 5 | 7 | 4 | 4 | 4 | 4 |

EXTRUDER 1:

| | | | | | | |
|---|---|---|---|---|---|---|
| RPM | 40.8 | 40.6 | 40.6 | 40.8 | 40.9 | 40.8 |
| Amperage | 10 | 8 | 9 | 10 | 10 | 10 |
| Zone 1 (° C.) | 181 | 180 | 179 | 180 | 180 | 180 |
| Zone 2 (° C.) | 175 | 175 | 175 | 175 | 175 | 175 |
| Zone 3 (° C.) | 173 | 171 | 168 | 172 | 178 | 178 |
| Upper Die (° C.) | 166 | 154 | 164 | 164 | 167 | 167 |
| Middle Die (° C.) | 163 | 162 | 166 | 167 | 167 | 166 |
| Lower Die (° C.) | 164 | 164 | 165 | 166 | 166 | 167 |
| Transfer Melt Temp (° C.) | 163 | 164 | 165 | 164 | 165 | 166 |
| Extruder Pressure (psi) | 2550 | 2190 | 1810 | 2160 | 1090 | 1910 |
| Transfer Pressure (psi) | 1430 | 1410 | 1110 | 850 | 950 | 920 |

EXTRUDER 2:

| | | | | | | |
|---|---|---|---|---|---|---|
| RPM | 3 | 3 | 3 | 3 | 3 | 3 |
| % Load | 19 | 20 | 21 | 19 | 19 | 19 |
| Zone 1 (° C.) | 165 | 165 | 165 | 165 | 165 | 165 |
| Zone 2 (° C.) | 165 | 165 | 165 | 165 | 165 | 165 |
| Zone 3 (° C.) | 165 | 165 | 165 | 165 | 165 | 165 |
| Zone 4 (° C.) | 165 | 165 | 165 | 165 | 165 | 165 |
| Zone 5 (° C.) | 165 | 165 | 165 | 165 | 165 | 165 |
| Adaptor Block 1 (° C.) | 165 | 165 | 165 | 165 | 165 | 165 |
| Adaptor Block 2 (° C.) | 164 | 166 | 166 | 166 | 166 | 166 |
| Die Temp (° C.) | 170 | 170 | 170 | 170 | 170 | 170 |
| Die Pressure (psi) | 1180 | 1340 | 740 | 540 | 570 | 580 |
| Head Pressure (psi) | 980 | 1140 | 390 | 290 | 330 | 340 |
| Rate (gr/min) | 120 | 114 | 120 | 125 | 122 | 115 |
| Foam Density (gr/cc) | 0.686 | 0.165 | 0.109 | 0.796 | 0.15 | 0.109 |
| Melt (° C.) | 160 | 157 | 156 | 157 | 156 | 155 |
| Average Cell Size (mm) | 0.28 | 0.56 | 0.84 | 0.42 | 1.68 | 1.40 |

Formulations 6, 15, and 18 contained no cell nucleation agent. Formulation 15 produced little foaming or expansion, and Formulation 18 also exhibited no expansion. However, Formulation 6 did produce foam, but of a heavy density (0.137 grams/cubic centimeter) and with very large cells (2.52 mm).

Formulations 4 and 11 used the same base and cell nucleation resin combinations, but Formulation 11 was injected with more gas (1750 psi and a flow rate of 5) than Formulation 4 (1390 psi and a flow rate of 4). Formulation 4 exhibited a lower density (0.110 gr/cc for Formulation 4 vs. 0.2937 for Formulation 11), while Formulation 11 exhibited a smaller cell size (0.56 mm for Formulation 11 vs. 0.98 mm for Formulation 4).

Formulations 13 and 20 used the same base and cell nucleation resin combinations, but Formulation 20 used less gas (1850 psi, flow rate 4) and a more open die than Formulation 13 (2410 psi, flow rate 5). Formulation 20 foam exhibited a lower density (0.109 gr/cc) and a large cell size, while Formulation 13 had a higher density (0.3622 gr/cc).

Formulations 14 and 19 used the same base and cell nucleation resin combinations, but Formulation 19 used less gas (1720 psi, flow rate 4) and a more open die than Formulation 13 (1920 psi, flow rate 5). Formulation 19 foam exhibited a lower density (0.150 gr/cc) and a large cell size, while Formulation 14 had a higher density (0.54 gr/cc).

Formulations 8, 9 and 10 used the same base and cell nucleation resin combinations. Formulations 8 and 9 produced foams of comparable densities and cell sizes. Formulation 10 used more gas, and the density increased while the cell size decreased, similar to the formulation pairings just discussed.

Formulations 1, 12, 16 and 17 used the same base and cell nucleation resin combinations. Formulations 1 and 12 produced foams of comparable densities and cell sizes. Formulation 16 used more gas (1960 psi, flow rate 7), while Formulation 17 used less (1470 psi, flow rate 4). As with the other comparisons, more gas produced a heavier, more dense foam with smaller cell size, while less gas produced a lighter foam with a larger average cell size.

In general, it appears that increasing the gas pressure and rate causes an unexpected increase in density in polyhydroxyalkanoate foams, although the cell size seems to be smaller. Inclusion of talc appears to be integral to the formation of cells in the foam. Likewise, increasing melt strength (such as through the use of branching agents such peroxide and reactive compounds such as Joncryl ADR-4368CS) is important to maintain cell integrity and reduce the density of the foam.

Other than in the examples herein, or unless otherwise expressly specified, all of the numerical ranges, amounts, values and percentages, such as those for amounts of materials, elemental contents, times and temperatures of reaction, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used). When percentages by weight are used herein, the numerical values reported are relative to the total weight.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

While this invention has been particularly shown and described with references to preferred embodiments thereof, it will be understood by those skilled in the art that various changes in form and details may be made therein without departing from the scope of the invention encompassed by the appended claims.

1-126. (canceled)

127. A composition for producing a PHA polymer foam, comprising:
a PHA polymer;
a branching agent;
a foam cell nucleating composition; and
a blowing agent, wherein the foam cell nucleating composition comprises a second PHA polymer, at least one epoxy functional compound and a foam cell nucleating agent.

128. The composition of claim 127, wherein the epoxy functional compound is an epoxy-functional styrene-acrylic polymer, an epoxy-functional acrylic copolymer, an epoxy-functional polyolefin copolymer, an oligomer comprising a glycidyl group with an epoxy functional side chain, an epoxy-functionalized poly(ethylene-glycidyl methacrylate-co-methacrylate), or an epoxidized oil or combinations thereof.

129. The composition of claim 127, wherein the foam cell nucleating agent is talc, clay or a combination thereof.

130. The composition of claim 127, wherein the composition further comprises a nucleating agent.

131. The composition of claim 130, wherein the nucleating agent is boron nitride or cyanuric acid.

132. The composition of claim 127, further comprising a second epoxy functional compound.

133. The composition of claim 127, further comprising an additive.

134. The composition of claim 127, wherein the resultant polymer foam has an expansion ratio of 5 to 30 times.

135. The composition of claim 127, wherein the polyhydroxyalkanoate polymer is a poly(3-hydroxybutyrate) homopolymer, a poly(3-hydroxybutyrate-co-4-hydroxybutyrate), a poly(3-hydroxybutyrate-co-3-hydroxyvalerate), a poly(3-hydroxybutyrate-co-5-hydroxyvalerate), a poly(3-hydroxybutyrate-co-3-hydroxyhexanoate), a poly(3-hydroxybutyrate-co-4-hydroxybutyrate) with 5% to 15% 4-hydroxybutyrate content, a poly(3-hydroxybutyrate-co-3-hydroxyvalerate) with 5% to 22% 3-hydroxyvalerate content, a poly(3-hydroxybutyrate-co-5-hydroxyvalerate) with 5% to 15% 5-hydroxyvalerate content, or a poly(3-hydroxybutyrate-co-3-hydroxyhexanoate) with 3% to 15% 3-hydroxyhexanoate content.

136. The composition of claim 127, wherein the polyhydroxyalkanoate polymer is a) a poly(3-hydroxybutyrate) homopolymer blended with b) a poly(3-hydroxybutyrate-co-4-hydroxybutyrate); a) a poly(3-hydroxybutyrate) homopolymer blended with b) a poly(3-hydroxybutyrate-co-3-hydroxyvalerate); a) a poly(3-hydroxybutyrate) homopolymer blended with b) a poly(3-hydroxybutyrate-co-3-hydroxyhexanoate); a) a poly(3-hydroxybutyrate-co-4-hydroxybutyrate) blended with b) a poly(3-hydroxybutyrate-co-3-hydroxyvalerate); a) a poly(3-hydroxybutyrate-co-4-hydroxybutyrate) blended with b) a poly(3-hydroxybutyrate-co-3-hydroxyhexanoate) a) a poly(3-hydroxybutyrate-co-3-hydroxyvalerate) blended with b) a poly(3-hydroxybutyrate-co-3-hydroxyhexanoate), a) a poly(3-hydroxybutyrate) homopolymer blended with b) a poly(3-hydroxybutyrate-co-4-hydroxybutyrate) with a 5% to 15% 4-hydroxybutyrate content; a) a poly(3-hydroxybutyrate) homopolymer blended with b) a poly(3-hydroxybutyrate-co-3-hydroxyvalerate) with a 5% to 22% 3-hydroxyvalerate content; a) a poly(3-hydroxybutyrate) homopolymer blended with b) a poly(3-hydroxybutyrate-co-3-hydroxyhexanoate) with a 3% to 15% 3-hydroxyhexanoate content; a) a poly(3-hydroxybutyrate-co-4-hydroxybutyrate) with a 5% to 15% 4-hydroxybutyrate content blended with b) a poly(3-hydroxybutyrate-co-3-hydroxyvalerate) with a 5% to 22% 3-hydroxyvalerate content; a) a poly(3-hydroxybutyrate-co-4-hydroxybutyrate) with 5% to 15% 4-hydroxybutyrate content blended with b) a poly(3-hydroxybutyrate-co-3-hydroxyhexanoate) with a 3% to 15% 3-hydroxyhexanoate content or a) a poly(3-hydroxybutyrate-co-3-hydroxyvalerate) with a 5% to 22% 3-hydroxyvalerate content blended with b) a poly(3-hydroxybutyrate-co-3-hydroxyhexanoate) with a 3% to 15% 3-hydroxyhexanoate content.

137. The composition of claim 136, wherein the biologically-produced polyhydroxyalkanoate is a) a poly(3-hydroxybutyrate) homopolymer blended with b) a poly(3-hydroxybutyrate-co-4-hydroxybutyrate) and the weight of polymer a) is 5% to 95% of the combined weight of polymer a) and polymer b); a) a poly(3-hydroxybutyrate) homopolymer blended with b) a poly(3-hydroxybutyrate-co-3-hydroxyvalerate) and the weight of polymer a) is 5% to 95% of the combined weight of polymer a) and polymer b); a) a poly(3-hydroxybutyrate) homopolymer blended to with b) a poly(3-hydroxybutyrate-co-3-hydroxyhexanoate) and the weight of polymer a) is 5% to 95% of the combined weight of polymer a) and polymer b); a) a poly(3-hydroxybutyrate-co-4-hydroxybutyrate) blended with b) a poly(3-hydroxybutyrate-co-3-hydroxyvalerate) and the weight of polymer a) is 5% to 95% of the combined weight of polymer a) and polymer b); a) a poly(3-hydroxybutyrate-co-4-hydroxybutyrate) blended with b) a poly(3-hydroxybutyrate-co-3-hydroxyhexanoate) and the weight of polymer a) is 5% to 95% of the combined weight of polymer a) and polymer b); or a) a poly(3-hydroxybutyrate-co-3-hydroxyvalerate) blended with b) a poly(3-hydroxybutyrate-co-3-hydroxyhexanoate) and the weight of polymer a) is 5% to 95% of the combined weight of polymer a) and polymer b).

138. The composition of claim 136, wherein the weight of polymer a) is 20% to 60% of the combined weight of polymer a) and polymer b) and the weight of polymer b) is 40% to 80% of the combined weight of polymer a) and polymer b).

139. The composition of claim 127, wherein the polyhydroxyalkanoate polymer is a) poly(3-hydroxybutyrate) homopolymer blended with b) a poly(3-hydroxybutyrate-co-4-hydroxybutyrate) with a 20-50% 4-hydroxybutyrate content; a) a poly(3-hydroxybutyrate) homopolymer blended with b) a poly(3-hydroxybutyrate-co-5-hydroxyvalerate) with a 20% to 50% 5-hydroxyvalerate content; a) a poly(3-hydroxybutyrate) homopolymer blended with b) a poly(3-hydroxybutyrate-co-3-hydroxyhexanoate) having a 5%-50% 3-hydroxyhexanoate content; a) poly(3-hydroxybutyrate-co-4-hydroxybutyrate) with a 5% to 15% 4-hydroxybutyrate content blended with b) a poly(3-hydroxybutyrate-co-4-hydroxybutyrate) with a 20-50% 4-hydroxybutyrate content; a) poly(3-hydroxybutyrate-co-4-hydroxybutyrate) with a 5% to 15% 4-hydroxybutyrate content blended with b) a poly(3-hydroxybutyrate-co-5-hydroxyvalerate) with a 20% to 50% 5-hydroxyvalerate content; a) a poly(3-hydroxybutyrate-co-4-hydroxybutyrate) with 5% to 15% 4-hydroxybutyrate content blended with b) a poly(3-hydroxybutyrate-co-3-hydroxyhexanoate) having a 5%-50% 3-hydroxyhexanoate content; a) a poly(3-hydroxybutyrate-co-3-hydroxyvalerate) with a 5% to 22% 3-hydroxyvalerate content blended with b) poly(3-hydroxybutyrate-co-4-hydroxybutyrate) with a 20-50% 4-hydroxybutyrate content; a) a poly(3-hydroxybutyrate-co-3-hydroxyvalerate) with a 5% to 22% 3-hydroxyvalerate content blended with b) a poly(3-hydroxybutyrate-co-5-hydroxyvalerate) with a 20% to 50% 5-hydroxyvalerate content; a) a poly(3-hydroxybutyrate-co-3-hydroxyvalerate) with a 5% to 22% 3-hydroxyvalerate content blended with b) a poly(3-hydroxybutyrate-co-3-hydroxyhexanoate) having a 5%-50% 3-hydroxyhexanoate content; a) a poly(3-hydroxybutyrate-co-3-hydroxyhexanoate) with a 3% to 15% 3-hydroxyhexanoate content blended with b) a poly(3-hydroxybutyrate-co-4-hydroxybutyrate) with a 20-50% 4-hydroxybutyrate content; a) a poly(3-hydroxybutyrate-co-3-hydroxyhexanoate) with a 3% to 15% 3-hydroxyhexanoate content blended with b) a poly(3-hydroxybutyrate-co-5-hydroxyvalerate) with a 20% to 50% 5-hydroxyvalerate; or a) a poly(3-hydroxybutyrate-co-3-hydroxyhexanoate) with a 3% to 15% 3-hydroxyhexanoate content blended with b) a poly(3-hydroxybutyrate-co-3-hydroxyhexanoate) having a 5%-50% 3-hydroxyhexanoate content.

140. The composition of claim 127, wherein the biologically-produced polyhydroxyalkanoate is a) a poly(3-hydroxybutyrate) homopolymer blended with b) a poly(3-hydroxybutyrate-co-4-hydroxybutyrate) with a 20-50% 4-hydroxybutyrate content and the weight of polymer a) is 5% to 95% of the combined weight of polymer a) and polymer b); a) a poly(3-hydroxybutyrate) homopolymer blended with b) a poly(3-hydroxybutyrate-co-3-hydroxyvalerate) with a 20% to 50% 5-hydroxyvalerate content and the weight of polymer a) is 5% to 95% of the combined weight of polymer a) and polymer b); a) a poly(3-hydroxybutyrate) homopolymer blended with b) a poly(3-hydroxybutyrate-co-3-hydroxyhexanoate) having a 5%-50% 3-hydroxyhexanoate content and the weight of polymer a) is 5% to 95% of the combined weight of polymer a) and polymer b); a) a poly(3-hydroxybutyrate-co-4-hydroxybutyrate) with a 5% to 15% 4-hydroxybutyrate content blended with b) poly(3-hydroxybutyrate-co-4-hydroxybutyrate) with a 20-50% 4-hydroxybutyrate content and the weight of polymer a) is 5% to 95% of the combined weight of polymer a) and polymer b); a) a poly(3-hydroxybutyrate-co-4-hydroxybutyrate) with a 5% to 15% 4-hydroxybutyrate content blended with b) poly(3-hydroxybutyrate-co-5-hydroxyvalerate) with a 20% to 50% 5-hydroxyvalerate and the weight of polymer a) is 5% to 95% of the combined weight of polymer a) and polymer b); a) a poly(3-hydroxybutyrate-co-4-hydroxybutyrate) with a 5% to 15% 4-hydroxybutyrate content blended with b) a poly(3-hydroxybutyrate-co-3-hydroxyhexanoate) having a 5%-50% 3-hydroxyhexanoate content and the weight of polymer a) is 5% to 95% of the combined weight of polymer a) and polymer b); a) a poly(3-hydroxybutyrate-co-3-hydroxyvalerate) with a 5% to 22% 3-hydroxyvalerate content blended with b) poly(3-hydroxybutyrate-co-4-hydroxybutyrate) with a 20-50% 4-hydroxybutyrate content and the weight of polymer a) is 5% to 95% of the combined weight of polymer a) and polymer b); a) a poly(3-hydroxybutyrate-co-3-hydroxyvalerate) with a 5% to 22% 3-hydroxyvalerate content blended with b) a poly(3-hydroxybutyrate-co-5-hydroxyvalerate) with a 20% to 50% 5-hydroxyvalerate and the weight of polymer a) is 5% to 95% of the combined weight of polymer a) and polymer b); a) a poly(3-hydroxybutyrate-co-3-hydroxyvalerate) with a 5% to 22% 3-hydroxyvalerate content blended with b) a poly(3-hydroxybutyrate-co-3-hydroxyhexanoate) having a 5%-50% 3-hydroxyhexanoate content and the weight of polymer a) is 5% to 95% of the combined weight of polymer a) and polymer b); a) a poly(3-hydroxybutyrate-co-3-hydroxyhexanoate) with a 3% to 15% 3-hydroxyhexanoate content blended with b) a poly(3-hydroxybutyrate-co-4-hydroxybutyrate) with a 20-50% 4-hydroxybutyrate content and the weight of polymer a) is 5% to 95% of the combined weight of polymer a) and polymer b); a) a poly(3-hydroxybutyrate-co-3-hydroxyhexanoate) with a 3% to 15% 3-hydroxyhexanoate content blended with b) a poly(3-hydroxybutyrate-co-5-hydroxyvalerate) with a 20% to 50% 5-hydroxyvalerate and the weight of polymer a) is 5% to 95% of the combined weight of polymer a) and polymer b); or a) a poly(3-hydroxybutyrate-co-3-hydroxyhexanoate) with a 3% to 15% 3-hydroxyhexanoate content blended with b) a poly(3-hydroxybutyrate-co-3-hydroxyhexanoate) having a 5%-50% 3-hydroxyhexanoate content and the weight of polymer a) is 5% to 95% of the combined weight of polymer a) and polymer b).

141. The composition of claim 139, wherein the weight of polymer a) is 20% to 60% of the combined weight of polymer a) and polymer b) and the weight of polymer b is 40% to 80% of the combined weight of polymer a) and polymer b).

142. The composition of claim 139, wherein the biologically-produced polyhydroxyalkanoate is further blended with polymer c) a poly(3-hydroxybutyrate-co-4-hydroxybutyrate) with a 20% to 50% 4-hydroxybutyrate content, a poly(3-hydroxybutyrate-co-5-hydroxyvalerate) with a 20% to 50% 5-hydroxyvalerate content or a poly(3-hydroxybutyrate-co-3-hydroxyhexanoate) with a 5% to 50% 3-hydroxyhexanoate content.

143. The composition of claim 127, wherein the polymer composition further comprises an aromatic/aliphatic polyester.

144. The composition of claim 143, wherein the biodegradable aromatic/aliphatic polyester is polybutylene adipate terephthalate, polyethylene adipate terephthalate, polybutylene succinate terephthalate or polyethylene succinate terephthalate.

145. The composition of claim 127, wherein the composition is a pellet.

146. The composition of claim 127, wherein the composition has a cell density of about 0.1 grams per cubic centimeter, about 0.14 grams per cubic centimeter, or about 0.69 gram per cubic centimeter.

147. The composition of claim 127, wherein the composition has an average cell size of about 0.28 millimeters, about 0.84 millimeters, about 2.5 millimeters or about.

148. The composition of claim 127, wherein the PHA polymer is poly-3-hydroxybutyrate-co-4-hydroxybutyrate (PHB4HB) having from about 2% to about 40% 4HB content, the epoxy functional compound is glycidyl methacrylate, the cell nucleating compound is talc, and the blowing agent is 1,1,1,2-tetrafluoroethane.

149. A method of preparing a PHA polymer foam, comprising:
a) combining a PHA polymer and a branching agent under conditions suitable for branching, thereby forming a branched PHA polymer,
b) combining the branched PHA polymer with an epoxy functional compound, a second PHA polymer, and a foam cell nucleating agent under conditions that cause reaction of the polymer with an epoxy functional compound, thereby forming a molten foam composition,
c) combining the molten foam composition with a blowing agent under conditions that cause foaming of the molten foam composition, and
d) cooling the foamed polymer composition,
thereby forming a polymer foam.

150. The method of claim 149, wherein the blowing agent is selected from the group consisting of 1,1,1,2-tetrafluoroethane, butane, carbon dioxide, nitrogen, pentane, isopentane and isobutane.

151. The method of claim 150, wherein the epoxy functional compound is selected from an epoxy-functional, styrene-acrylic polymer, a glycidyl methacrylate or an epoxidized soybean oil.

152. The method of claim 149, wherein the cell nucleating agent is talc or clay.

153. A foam made by the method of claim 149.

154. A method of making a cell nucleation pellet, the method comprising:
providing a polyhydroxyalkanoate polymer;
providing an epoxy functional compound;
dispersing the epoxy functional compound into the polymer under conditions that cause melting of the polymer, thereby forming a cell nucleation composition; and
cooling and shaping the cell nucleation composition to form a cell nucleation pellet;
thereby making a cell nucleation pellet.

155. The method of claim 154, wherein the epoxy functional compound is selected from an epoxy-functional, styrene-acrylic polymer, a glycidyl methacrylate or an epoxidized soybean oil.

156. The method of claim 154, wherein the polyhydroxyalkanoate is selected from the group consisting of: poly-3-hydroxybutyrate (PHB), poly-3-hydroxyvalerate (PHV), poly-3-hydroxybutyrate-co-4-hydroxybutyrate (PHB4HB) having from about 2% to about 40% 4HB content, a mixture of PHB and PHB4HB, a mixture of poly-3-hydroxybutyrate and (poly(3-hydroxybutyrate-co-10-13%-poly(4-hydroxybutyrate) and (poly(3-hydroxybutyrate-co-26-35%-poly(4-hydroxybutyrate), poly-3-hydroxybutyrate-co-3-hydroxyvalerate (PHBV), a mixture of PHB and PHBV, poly-3-hydroxybutyrate-co-3-hydroxyhexanoate (PHBH) having from about 3% to 15% H content, a mixture of PHB and PHBH; and a mixture of PHB and poly-3-hydroxybutyrate-co-3-hydroxy-X, where X is C₇-C₁₈ alkyl or mixture thereof.

157. A method of making a polymer foam, the method comprising:
providing a base polymer and branching agent;
providing a cell nucleation composition, wherein the cell nucleation composition comprises one or more epoxy functional compounds;
combining the base polymer and the cell nucleation composition under conditions that cause melting and mixing of the polymer and the cell nucleation composition, thereby forming a molten foam composition;
combining the molten foam composition with a blowing agent under conditions that cause foaming of the molten foam composition, thereby forming a foamed polymer composition; and
cooling the foamed polymer composition to form a polymer foam;
thereby forming a polymer foam.

158. A method of making a polymer foam, the method comprising:
providing a base polyhydroxyalkanoate polymer;
providing a branching agent;
providing a cell nucleation composition, wherein the cell nucleation composition comprises one or more epoxy functional compounds, a second polyhydroxyalkanoate polymer and one or more cell nucleating compounds and optionally a nucleating agent;
combining the base polymer and the cell nucleation composition under conditions that cause melting and mixing of the polymer and the cell nucleation composition, thereby forming a molten foam composition;
combining the molten foam composition with a blowing agent under conditions that cause foaming of the molten foam composition, thereby forming a foamed polymer composition; and
cooling the foamed polymer composition to form a polymer foam;
thereby forming a polymer foam.

159. The method of claim 158, wherein the epoxy functional compound is an epoxy-functional, styrene-acrylic polymer or a glycidyl methacrylate.

160. The method of claim 159, wherein the glycidyl methacrylate is LOTADER®.

161. The method of claim 158, wherein the cell nucleating compound is talc or clay.

162. The method of claim 158, wherein the polyhydroxyalkanoate is selected from the group consisting of: poly-3-hydroxybutyrate (PHB), poly-3-hydroxyvalerate (PHV), poly-3-hydroxybutyrate-co-4-hydroxybutyrate (PHB4HB) having from about 2% to about 40% 4HB content, a mixture of PHB and PHB4HB, a mixture of poly-3-hydroxybutyrate and (poly(3-hydroxybutyrate-co-10-13%-poly(4-hydroxybutyrate) and (poly(3-hydroxybutyrate-co-26-35%-poly(4-hydroxybutyrate), poly-3-hydroxybutyrate-co-3-hydroxyvalerate (PHBV), a mixture of PHB and PHBV, poly-3-hydroxybutyrate-co-3-hydroxyhexanoate (PHBH) having from about 3% to 15% H content, a mixture of PHB and PHBH; and a mixture of PHB and poly-3-hydroxybutyrate-co-3-hydroxy-X, where X is C₇-C₁₈ alkyl or mixture thereof.

163. The method of claim 158, wherein the blowing agent is selected from the group consisting of 1,1,1,2-tetrafluoroethane, butane, carbon dioxide, and nitrogen.

164. The method of claim 158, wherein the polymer is poly-3-hydroxybutyrate-co-4-hydroxybutyrate (PHB4HB) having from about 2% to about 40% 4HB content, the epoxy functional compound is glycidyl methacrylate, the cell nucleating compound is talc, and the blowing agent is selected from the group consisting of 1,1,1,2-tetrafluoroethane, butane, carbon dioxide, and nitrogen.
